(19) United States
(12) Patent Application Publication
(10) Pub. No.: US 2005/0120231 A1
(43) Pub. Date: Jun. 2, 2005

(54) Method and system for controlling network connection, and computer product

(75) Inventors: Tetsuya Harada, Kawasaki (JP); Ichiro Suzuki, Kawasaki (JP); Yoichiro Tsujii, Kawasaki (JP); Masayuki Iwasa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/856,196

(22) Filed: May 28, 2004

(30) Foreign Application Priority Data
Dec. 1, 2003 (JP) 2003-401995

(51) Int. Cl. H04L 9/32

(52) U.S. Cl. 713/189

(57) ABSTRACT

A terminal device and a control server device are connected with each other via a switch. The switch is connected to a network. The switch includes a communication processing unit that accepts connection propriety information and controls the connection of the terminal device to the network using the connection propriety information. The connection propriety information is information about whether the terminal device is allowed to be connected to the network and it is generated by the control server device based on security countermeasure level data of the terminal device.

### BACKGROUND OF THE INVENTION

1) Field of the Invention

The present invention relates to a technology for controlling network connections so as to prevent computers on the network form viral infections.

2) Description of the Related Art

It is common to exchange data using recording mediums such as FDs (flexible disks) and CD-Ra (CD recordable), or via networks.

It is also common to perform access restriction in which access is allowed to only certain computers. For example, the access restriction is performed using a switch that connects the computer to the network or using a radio network access point to connect computers to network according to the standards such as IEEE802.1x.

However, the access restriction is not enough to protect a computer from computer viruses; because, the computer of the authenticated user could be infected.

Virus infection protective methods are known. In the technology disclosed in Japanese Patent Application Laid-Open No. H7B81980, for example, virus inspection information of a computer is checked before making communications with that computer, and communications are started only when it can be confirmed that it is safe to perform communication with that computer. However, there is a problem that it is necessary to be apply the method to all the computers that are connected via a network.

Accordingly, it has been an important subject to develop a practical method that enables not only to prevent virus infection between a user's own computer and its partner computer, but also to prevent virus infection to other computers connected to network.

### SUMMARY OF THE INVENTION

It is an object of the present invention to solve at least the problems in the conventional technology.

A network connection control program according to an aspect of the present invention is run on a computer and relays communications by specified computers via a network, and controls connections of the specified computers to the network. The network connection control program makes the computer execute the steps including accepting connection control information about connection control generated on the basis of security countermeasure condition information about computer security countermeasure conditions of specified computers; and controlling the connections of the specified computers to the network on the basis of the connection control information accepted at the accepting step.

A network connection control program according to another aspect of the present invention is run on a computer and relays communications by specified computers via a network, and controls connections of the specified computers to the network. The network connection control program makes the computer execute the steps including accepting security countermeasure condition information about computer security countermeasure conditions of the specified computers; judging whether the security countermeasure conditions accepted are sufficient; and controlling the connections of the specified computers to the network on the basis of a result obtained at the judging step.

A network connection control method according to still another aspect of the present invention is a method of relaying communications by specified computers via a network, and controlling connections of the specified computers to the network. The network connection control method includes accepting connection control information about connection control generated on the basis of security countermeasure condition information about computer security countermeasure conditions of specified computers; and controlling the connections of the specified computers to the network on the basis of the connection control information accepted at the accepting.

A network connection control method according to still another aspect of the present invention is a method of relaying communications by specified computers via a network, and controlling connections of the specified computers to the network. The network connection control method includes accepting security countermeasure condition information about computer security countermeasure conditions of the specified computers; judging whether the security countermeasure conditions accepted are sufficient; and controlling the connections of the specified computers to the network on the basis of a result obtained at the judging.

A network connection control device according to still another aspect of the present invention relays communications by specified computers via a network, and controls connections of the specified computers to the network. The network connection control device includes an accepting unit that accepts connection control information about connection control generated on the basis of security countermeasure condition information about computer security countermeasure conditions of specified computers; and a controlling unit that controls the connections of the specified computers to the network on the basis of the connection control information accepted by the accepting unit.

A network connection control device according to still another aspect of the present invention relays communications by specified computers via a network, and controls connections of the specified computers to the network. The network connection control device includes an accepting unit that accepts security countermeasure condition information about computer security countermeasure conditions of the specified computers; a judging unit that judges whether the security countermeasure conditions accepted are sufficient; and a controlling unit that controls the connections of the specified computers to the network on the basis of a result obtained by the judging unit.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a functional block diagram of the network connection control system according to a first embodiment;

FIG. 2 is an example of security countermeasure level data 50 that the terminal device 10 sends;

FIG. 3 is an example of security countermeasure level transfer data 60 that the switch 20 sends;

FIG. 4 is an example of the port control table 22 shown in FIG. 1;

FIG. 5 is an example of the judgment result data 70 sent to the control server device 30;

FIG. 6 is an example of the connection condition data 32 shown in FIG. 1;

FIG. 7A is a flow chart (1) of the process procedure of the connection control process that the switch 20 according to the first embodiment conducts;

FIG. 7B is a flow chart (2) of the process procedure of the connection control process that the switch 20 according to the first embodiment conducts;

FIG. 8 is a flow chart of the process procedure of the connection propriety judgment process that the control server device 30 according to the first embodiment conducts;

FIG. 9 is a functional block diagram of a network connection control system according to a second embodiment;

FIG. 10 is an example of the port control table 92 shown in FIG. 9;

FIG. 11 is an example of the judgment result data 140 sent to the control server device 100;

FIG. 12 is an example of the connection condition data 102 shown in FIG. 9

FIG. 13A is a flow chart (1) of the process procedure of the connection control process that the switch 90 according to the second embodiment conducts;

FIG. 13B is a flow chart (2) of the process procedure of the connection control process that the switch 90 according to the second embodiment conducts;

FIG. 14 is a flow chart of the process procedure of the switching destination VLAN judgment process that the control server device 100 according to the second embodiment performs;

FIG. 15 is a functional block diagram of a network connection control system according to a third embodiment;

FIG. 16 is an example of the port control table 162 shown in FIG. 15;

FIG. 17 is an example of the connection condition data 172 shown in FIG. 15;

FIG. 18 is a functional block diagram of a network connection control system according to a fourth embodiment;

FIG. 19 is a functional block diagram of a network connection control system according to a fifth embodiment;

FIG. 20 is an example of security countermeasure level data 310 that the terminal device 260 sends;

FIG. 21 is an example of security countermeasure level transfer data 320 that the switch 270 sends;

FIG. 22A is a flow chart (1) of the process procedure of the connection control process that the switch 270 according to the fifth embodiment conducts;

FIG. 22B is a flow chart (2) of the process procedure of the connection control process that the switch 270 according to the fifth embodiment conducts;

FIG. 23 is a flow chart of the process procedure of the user authentication process that the authentication server device 280 according to the fifth embodiment performs;

FIG. 24 is a functional block diagram of a network connection control system according to a sixth embodiment;

FIG. 25 is a functional block diagram of a network connection control system according to a seventh embodiment; and

FIG. 26 is a block diagram showing the structure of a computer 500 in a modified example of the embodiment.

### DETAILED DESCRIPTION

Exemplary embodiments of a network connection control program, a network connection control method, and a network connection control system according to the present invention are explained below by referring to the accompanying drawings. A switch is assumed here as an example of the network connection control system.

The switch is a network device to relay data received from computers, and send data to a port connected to a destination computer via network. However, the present invention is not limited to the switch, but may be applied also to any network device such as a radio network access point having similar functions in the same manners.

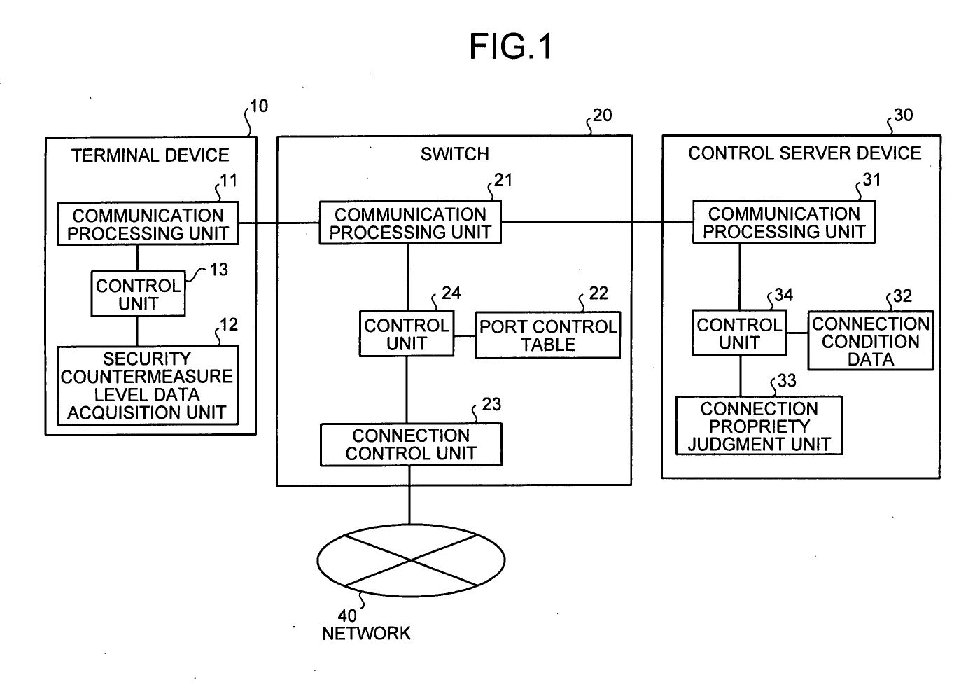

The structure of a network connection control system according to a first embodiment is explained hereinafter. FIG. 1 is a functional block diagram of the network connection control system according to a first embodiment.

In this network connection control system, a terminal device 10 and a control server device 30 are connected with each other via a switch 20. Moreover, the switch 20 is connected to a network 40 to which plural terminal devices and server devices (not shown) are connected.

The terminal device 10 is a terminal device such as a personal computer to which various application software programs are installed. The terminal device 10 includes a communication processing unit 11, a security countermeasure level data acquisition unit 12 and a control unit 13.

The communication processing unit 11 is a communication processing unit that carries out communications with other connected terminal devices, server devices, the switch 20 and the like via the network. The security countermeasure level data acquisition unit 12 is an acquisition unit that acquires the computer virus countermeasure conditions of the terminal device 10 as security countermeasure level data. The acquired security countermeasure level data is sent by the communication processing unit 11 to the switch 20.

By the way, the connection of a terminal device not having the security countermeasure level data acquisition unit 12 to the network 40 is rejected; therefore, a software program that realizes the functions of the security countermeasure level data acquisition unit 12 must be installed in such a terminal device.

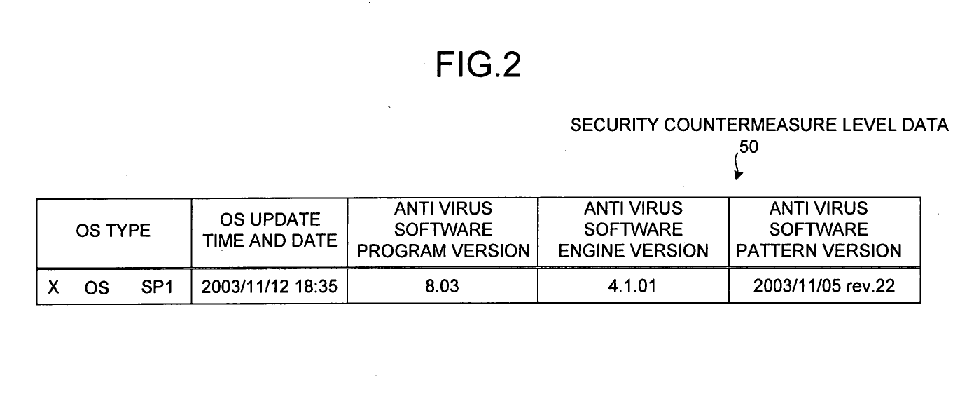

FIG. 2 is an example of security countermeasure level data 50 that the terminal device 10 sends. The security countermeasure level data 50 includes information pieces of OS (Operating System) type, OS update time and date, anti virus software program version, anti virus software engine version, and anti virus software pattern version.

The OS type is the information about the type of an OS installed in the terminal device 10. The OS update time and date is the information about the time and date of an update of the OS. The anti virus software program version is the information about the version of the anti virus software program installed in the terminal device 10. The anti virus software engine version is the information about the version of the engine of the anti virus software program that detects and deletes a virus. The anti virus software pattern version is the information about the version of the virus detection pattern to which the anti virus engine refers.

The security countermeasure level data is made as one including the above respective items, but the security countermeasure level data is not limited to this, but may further include information pieces about the installation conditions of various application software programs and the like. Thereby, the system can cope with even a case wherein for example an application software program that is likely to be infected by computer viruses is installed in the terminal device 10.

Back to the explanation of FIG. 1, the control unit 13 is a control unit that entirely controls the terminal device 10, and sends and receives data with the respective functional units.

The switch 20 is a network device that relays data received from the terminal device 10, and sends data to a port to which a terminal device or a server device as a destination is connected via the network 40.

The switch 20 not only relays data, but also, when it receives the security countermeasure level data 50 from the terminal device 10, it transfers the received security countermeasure level data 50 to the control server device 30. The control server device 30 judges whether or not to allow the terminal device 10 to send the data via the network 40, on the basis of the sent security countermeasure level data 50.

Then, the switch 20 receives the judgment result of connection propriety sent by the control server device 30, and memorizes the connection propriety information in correspondence with the port to which the terminal device 10 is connected. When the data is sent by the terminal device 10, on the basis of the memorized connection propriety information, the switch 20 carries out a process to connect the terminal device 10 to the network 40 or a process to reject the connection.

The switch 20 includes a communication processing unit 21, a port control table 22, a connection control unit 23, and a control unit 24. The communication processing unit 21 is a communication processing unit that communicates with the terminal device 10 and the control server device 30. The communication processing unit 21 also carries out a process to relay communications with a terminal device or a server device connected to the terminal device 10 and the network 40.

Concretely, when the data accepted from the terminal device 10 is the security countermeasure level data 50, this communication processing unit 21 generates security countermeasure level transfer data wherein the information of the port that has accepted the data is added to the security countermeasure level data 50, and transfers that data to the control server device 30. While, when the data accepted from the terminal device 10 is other data than the security countermeasure level data 50, the communication processing unit 21 transfers that data to the connection control unit 23.

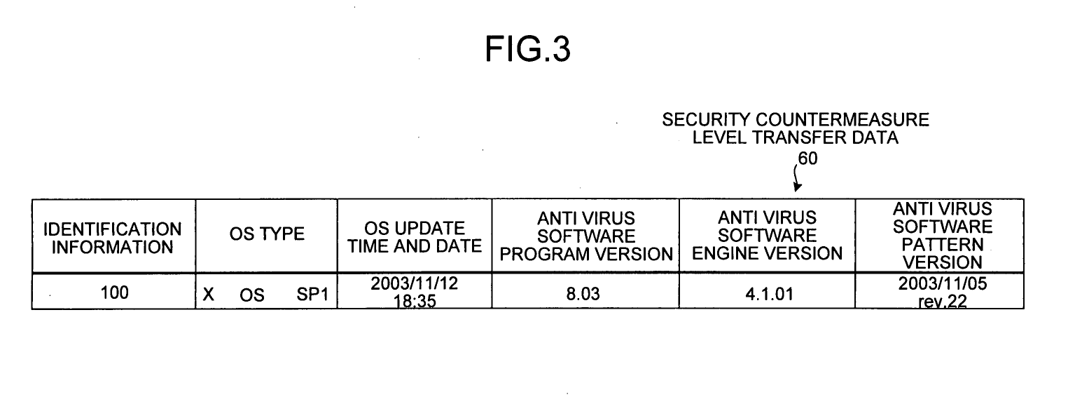

FIG. 3 is an example of security countermeasure level transfer data 60 that the switch 20 sends. As shown in FIG. 3, this security countermeasure level transfer data 60 includes information pieces of identification information, OS (Operating System) type, OS update time and date, anti virus software program version, anti virus software engine version, and anti virus software pattern version.

The identification information is an identification number that identifies the port at which the switch 20 accepts the data from the terminal device 10, while the OS (Operating System) type, the OS update time and date, the anti virus software program version, the anti virus software engine version, and the anti virus software pattern version are the respective information pieces included in the security countermeasure level data 50.

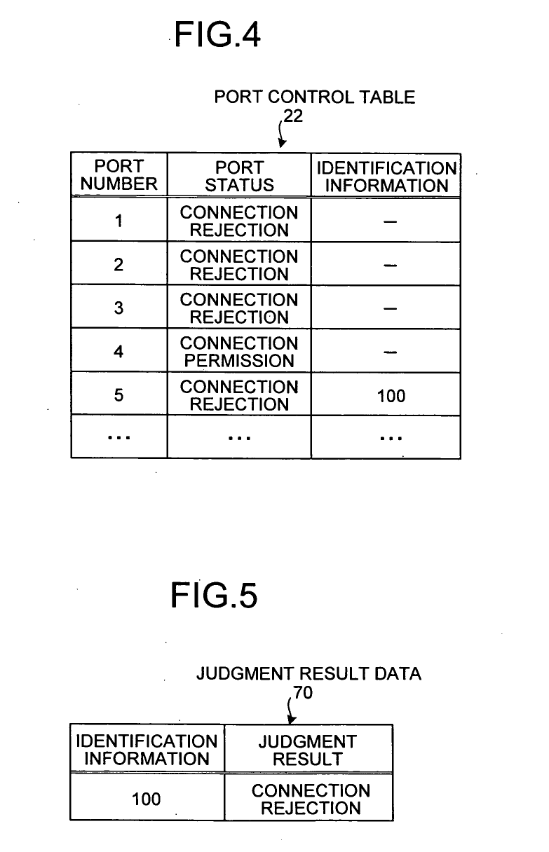

Back to the explanation of FIG. 1, the port control table 22 is a table wherein the information about the communication permission or rejection set to each communication port of the switch 20 is registered. FIG. 4 is an example of the port control table 22 shown in FIG. 1.

As shown in FIG. 4, in this port control table 22, respective information pieces of port number, port status, and identification information are registered. The port number is an identification number that identifies the respective ports that the switch 20 has. The port status is information showing connection acceptance or rejection set to ports to which respective terminal devices are connected. By the way, in the default status before the control server device 30 judges connection acceptance or rejection to the network 40 of the terminal device 10, the port status is set to “connection rejection”.

The identification information is information that identifies the port at which the security countermeasure level data 50 is accepted from the terminal device 10. The identification information is generated at the moment when the security countermeasure level data 50 is accepted from the terminal device 10, and is sent together with the security countermeasure level data 50 to the control server device 30.

The connection control unit 23 is a control unit that refers to the port control table 22, when it receives data from the terminal device 10 to a terminal device or a server device connected to the network 40, and thereby judges the connection propriety to the network 40.

Concretely, the connection control unit 23 rejects the connection to the network 40 when the port status corresponding to the port that has received data is set to “connection rejection” in the port control table 22, while it permits the connection to the network 40, and carries out a process to send data to the port to which the terminal device or the server device at communication destination when the port status is set to “connection permission”.

The connection control unit 23 sends the security countermeasure level transfer data 60 wherein identification information is added to the security countermeasure level data 50, to the control server device 30, and when it receives judgment result data showing the identification information and connection acceptance or rejection judgment result from the control server device 30 in response thereto, it carries out a process to set the port status of the port corresponding to the identification information concerned in the port control table 22 to “connection rejection” or “connection permission”.

FIG. 5 is an example of the judgment result data 70 that is sent to the control server device 30. As shown in FIG. 5, this judgment result data 70 includes identification information and judgment result information. The identification information is the information that identifies ports of the switch 20, and the judgment result is the information showing connection acceptance or rejection judged by the control server device 30.

Back to the explanation of FIG. 1, the control unit 24 is a control unit that entirely controls the terminal device 20, and sends and receives data with the respective functional units.

The control server device 30 is a unit that receives the security countermeasure level transfer data 60 from the switch 20, and judges whether or not to permit the connection of the terminal device 10 to the network 40, on the basis of the security countermeasure level data 50 included in the security countermeasure level transfer data 60.

The control server device 30 includes a communication processing unit 31, connection condition data 32, a connection propriety judgment unit 33 and a control unit 34. The communication processing unit 31 is a communication processing unit that communicates with the switch 20, and receives the security countermeasure level transfer data 60 sent from the switch 20, and sends out judgment result data 70 to the switch 20.

The connection condition data 32 is data that is referred to at the moment of judgment whether or not to connect the terminal device 10 to the network 40, and memorizes the conditions to decide connection propriety.

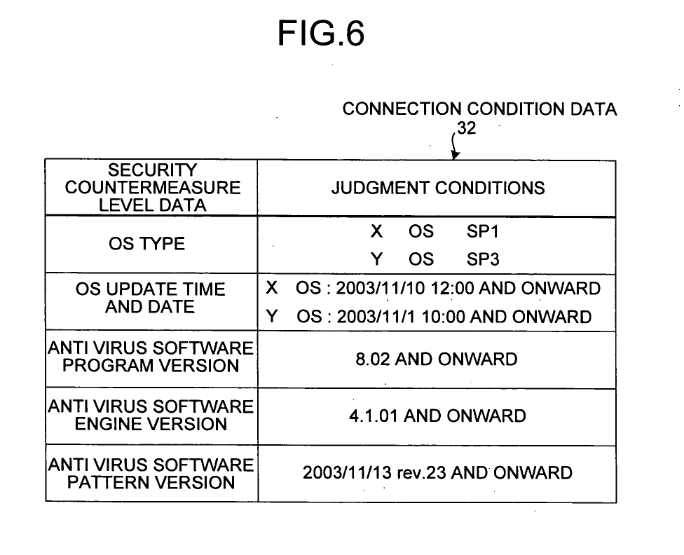

FIG. 6 is an example of the connection condition data 32 shown in FIG. 1. As shown in FIG. 6, in this connection condition data 32, respective information pieces of security countermeasure level and judgment conditions are registered.

The security countermeasure level includes respective items selected to judge the conditions of computer virus countermeasures, which correspond to the respective items included in the security countermeasure level data 50 that is sent by the terminal device 10. The judgment conditions are conditions that the respective items registered in the security countermeasure level should satisfy.

By the way, herein, the connection condition data 32 is to be memorized in the control server device 30, while in place of this, inquiries may be made to a server device that an anti virus software vender or the like holds, and the connection condition data memorized in the server device may be referred to.

Back to the explanation of FIG. 1, the connection propriety judgment unit 33 judges whether the respective items of the security countermeasure level data 50 included in the security countermeasure level transfer data 60 that the connection processing unit 31 has received satisfy the respective judgment conditions memorized in the connection condition data 32 or not, and generates the judgment result data 70 shown in FIG. 5, and carries out a process to send the judgment result data via the communication processing unit 31 to the switch 20.

The control unit 34 is a control unit that entirely controls the control server device 30, and sends and receives data with the respective functional units.

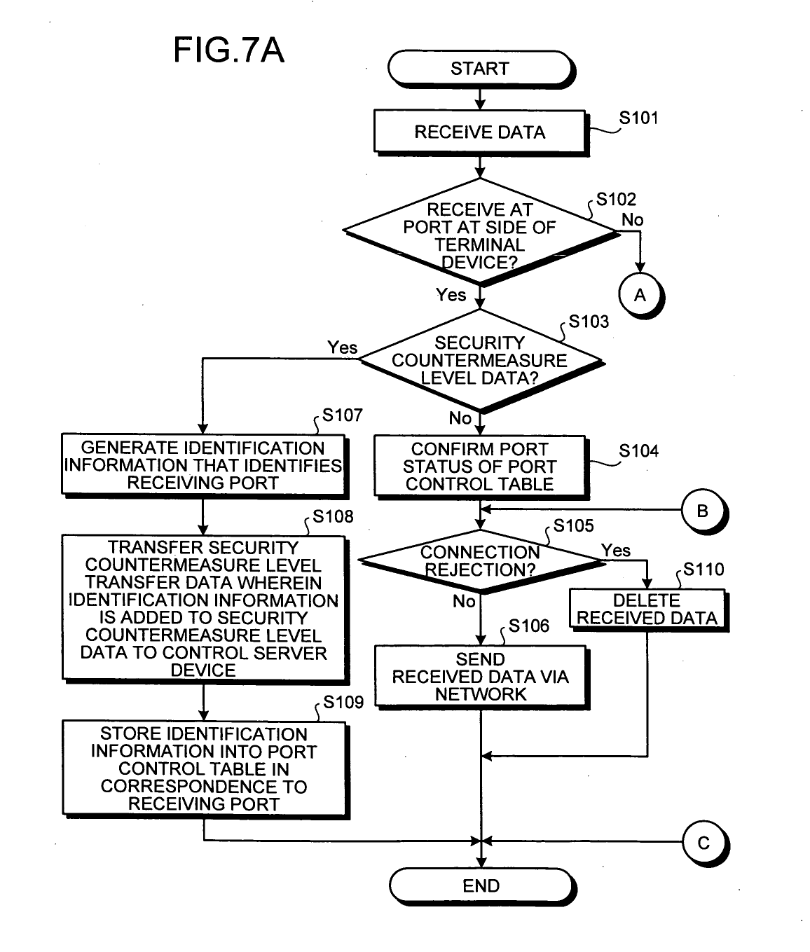

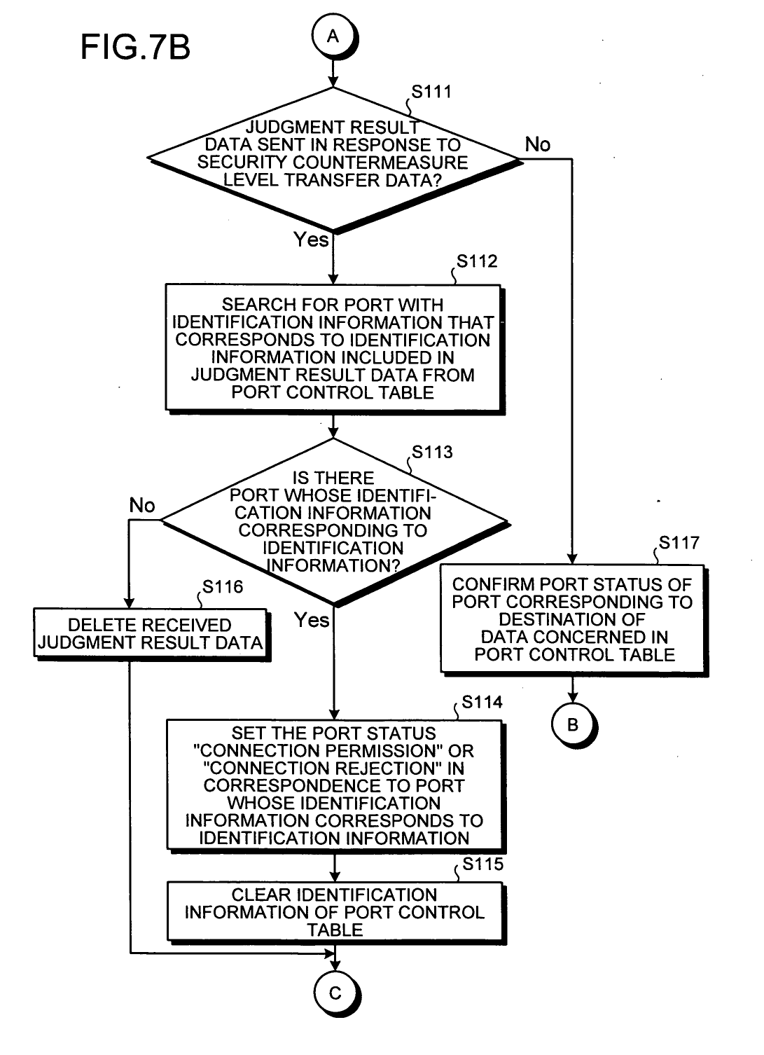

The process procedure of the connection control process that the switch 20 according to the first embodiment performs is explained hereinafter. FIG. 7A and FIG. 7B are flow charts (1) and (2) respectively showing the process procedure of the connection control process that the switch 20 according to the first embodiment conducts.

As shown in FIG. 7A, first, the communication processing unit 21 of the switch 20 receives data (step S101). The communication processing unit 21 judges whether the data has be received at the port at the side of the terminal device 10 or not (step S102), and when the data has been received at the port at the side of the terminal device 10 (step S102, Yes), the communication processing unit 21 checks whether the received data is the security countermeasure level data 50 or not (step S103).

When the received data is not the security countermeasure level data 50 (step S103, No), the connection control unit 23 confirms the port status corresponding to the port that has received the data in reference to the port control table 22 (step S104), and checks whether the port status is “connection rejection” or not (step S105).

When the port status is not “connection rejection” (step S105, No), the connection control unit 23 sends the data received from the terminal device 10 to a terminal device or a server device at destination via the network 40 (step S106), and completes the connection control process. When the port status is “connection rejection” (step S105, Yes), the connection control unit 23 deletes the data received from the terminal device 10 (step S110), and completes the connection control process.

In the step S103, when the data received from the terminal device 10 is the security countermeasure level data 50 (step S103, Yes), the communication processing unit 21 generates identification information that identifies the port that has received the data (step S107), and transfers the security countermeasure level transfer data 60 wherein the identification information is added to the security countermeasure level data 50 to the control server device 30 (step S108).

Then, the communication processing unit 21 stores the generated identification information into the port control table 22 in correspondence to the port that has received the data (step S109), and completes the connection control process.

In the step S102, when the data has not been received at the port at the side of the terminal device 10, but received at the port at the side of the control server device 30 (step S102, No), as shown in FIG. 7B, the communication processing unit 21 checks whether the received data is the judgment result data 70 sent in response to the security countermeasure level transfer data 60 sent to the control server device 30 or not (step S111).

When the received data is the judgment result data 70 (step S111, Yes), the connection control unit 23 searches for a port with identification information that corresponds to the identification information included in the judgment result data 70 from the port control table 22 (step S112), and checks whether there is a port whose identification information corresponds to the identification information included in the judgment result data or not (step S113).

When there is a port whose identification information corresponds to the identification information included in the judgment result data (step S113, Yes), the connection control unit 23 sets the port status “connection permission” or “connection rejection” in correspondence to the port whose identification information corresponds to the identification information included in the judgment result data (step S114), and clears the identification information of the port control table 22 (step S115), and completes the connection control process. When there is not any port whose identification information corresponds to the identification information included in the judgment result data (step S113, No), the connection control unit 23 deletes the received judgment result data 70 (step S116), and completes the connection control process.

In the step S111, when the received data is not the judgment result data 70 (step S111, No), the connection control portion 23 confirms the port status of the port corresponding to the destination of the data concerned in the port control table 22 (step S117), and as shown in FIG. 7A, checks whether the port status is “connection rejection” or not (step S105).

When the port status is not “connection rejection” (step S105, No), the connection control unit 23 sends the data received from the control server device 30 to the terminal device or server device at destination via the network 40 (step S106), and completes the connection control process. When the port status is “connection rejection” (step S105, Yes), the connection control unit 23 deletes the data received from the control server device 30 (step S110), and completes the connection control process.

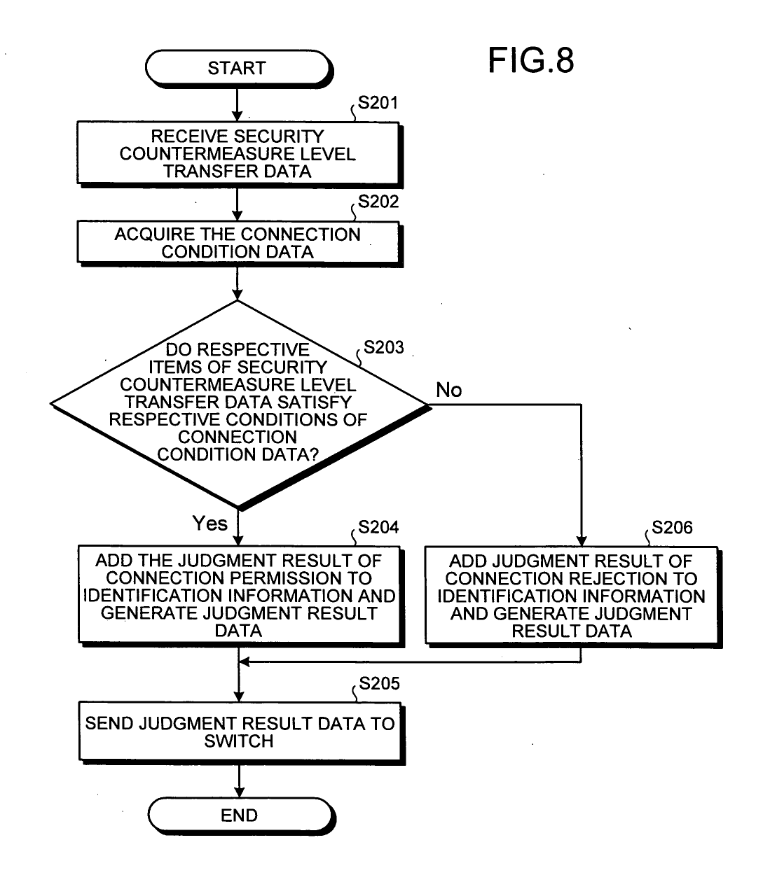

The process procedure of the connection propriety judgment process that the control server device 30 according to the first embodiment performs is explained hereinafter. FIG. 8 is a flow chart of the process procedure of the connection propriety judgment process that the control server device 30 according to the first embodiment conducts.

As shown in FIG. 8, first, the communication processing unit 31 of the control server device 30 receives the security countermeasure level transfer data 60 sent by the switch 20 (step S201). The connection propriety judgment unit 33 acquires the connection condition data 32 (step S202), and checks whether the respective items of the security countermeasure level data 50 included in the received security countermeasure level transfer data 60 satisfy the respective conditions of the connection condition data 32 or not (step S203).

When the respective items of the security countermeasure level data included in the received security countermeasure level transfer data satisfy the respective conditions of the connection condition data 32 (step S203, Yes), the connection propriety judgment unit 33 adds the judgment result of “connection permission” to the identification information and thereby generates the judgment result data 70 (step S204). Then, the communication processing unit 31 sends the judgment result data 70 generated by the connection propriety judgment unit 33 to the switch 20 (step S205).

When the respective items of the security countermeasure level data included in the received security countermeasure level transfer data do not satisfy the respective conditions of the connection condition data 32 (step S203, No), the connection propriety judgment unit 33 adds the judgment result of “connection rejection” to the identification information and thereby generates the judgment result data 70 (step S206). Then, the communication processing unit 31 sends the judgment result data 70 generated by the connection propriety judgment unit 33 to the switch 20 (step S205).

As mentioned above, in the first embodiment, the communication processing unit 21 of the switch 20 receives the connection propriety information of the terminal device 10 to the network 40 judged by the control server device 30 on the basis of the security countermeasure level data 50 of the terminal device 10, and on the basis of the received information, the communication processing unit 21 controls the connection of the terminal device 10 to the network 40, accordingly, the first embodiment makes it possible to appropriately prevent a computer virus from infecting from a terminal device 10 whose security countermeasures are insufficient to other terminal devices or server devices connected to the network 40.

By the way, in the first embodiment, when it is judged that the security countermeasures of the terminal device are insufficient, the switch controls the connection of the terminal device to the network, while in place of this, the switch may control the connection to a VLAN (Virtual Local Area Network) wherein a network is logically divided.

Concretely, when security countermeasures are insufficient, by restricting the system so that the terminal device can carry out communications only in a VLAN wherein a server device that can update an OS and an anti virus software program is connected, even if the terminal device is infected by a computer virus, the system makes it possible to prevent the infection from spreading over other devices connected to the network. Further, it is possible to prevent the terminal device from being infected by a computer virus from other devices during the terminal device is updating an OS or an anti virus software program. Therefore, in a second embodiment, a case wherein the switch controls the connection to a VLAN is explained hereinafter.

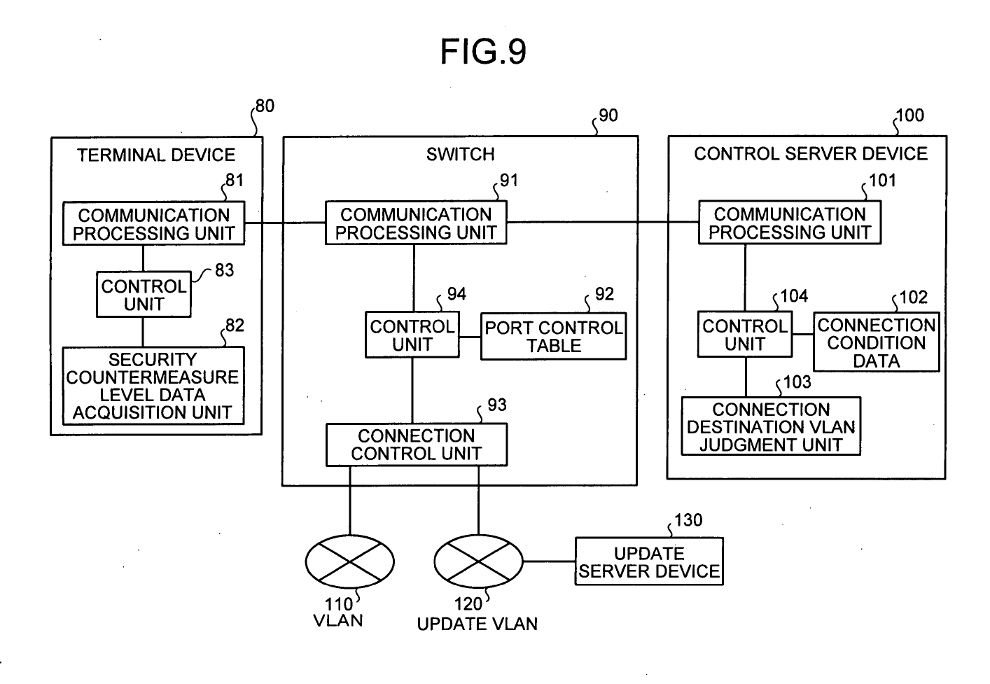

In the first place, the structure of a network connection control system according to the second embodiment is explained hereinafter. FIG. 9 is a functional block diagram of a network connection control system according to the second embodiment. By the way, detailed explanations about the similar functional units to those in the first embodiment shown in FIG. 1 are omitted hereinafter.

As shown in FIG. 9, in this network connection control system, a terminal device 80 and a switch 90 are connected with each other, and the switch 90 and a control server device 100 are connected with each other, and a VLAN 110 wherein a network is logically divided, and an update VLAN 120 are connected to the switch 90.

The update VLAN 120 is a VLAN wherein the terminal device 80 is connected to an update server device 130 that can update an OS or an anti virus software program, while the VLAN 110 is a VLAN that is used when the terminal device 80 carries out communications with other terminal device or server device (not shown).

The terminal device 80 is a terminal device such as a personal computer to which various application software programs are installed, and a communication processing unit 81, a security countermeasure level data acquisition unit 82 and a control unit 83 that the terminal device 80 holds have the functions similar to those of the communication processing unit 11, the security countermeasure level data acquisition unit 12 and the control unit 13 shown in FIG. 1.

The switch 90 is a network device that relays data received from the terminal device 80, and sends data to a port of the VLAN 110 or the update VLAN 120 to which a terminal device or a server device as a destination is connected.

The switch 90 not only relays data, but also, when it receives the security countermeasure level data similar to that shown in FIG. 2 from the terminal device 80, it transfers the received security countermeasure level data to the control server device 30. The control server device 100 judges the VLAN to which the terminal device 80 should be connected, on the basis of the security countermeasure level data.

Then, the switch 90 receives the judgment result sent by the control server device 100, and memorizes the VALN information in correspondence with the port to which the terminal device 80 is connected. When the data is sent by the terminal device 80, on the basis of the memorized VLAN information, the switch 90 carries out a process to connect the terminal device 80 to the VLAN 110 or the update VLAN 120 or a process to reject the connection.

The switch 90 includes a communication processing unit 91, a port control table 92, a connection control unit 93, and a control unit 94. The communication processing unit 91 is a communication processing unit that has the functions similar to those of the communication processing unit 21 shown in FIG. 1.

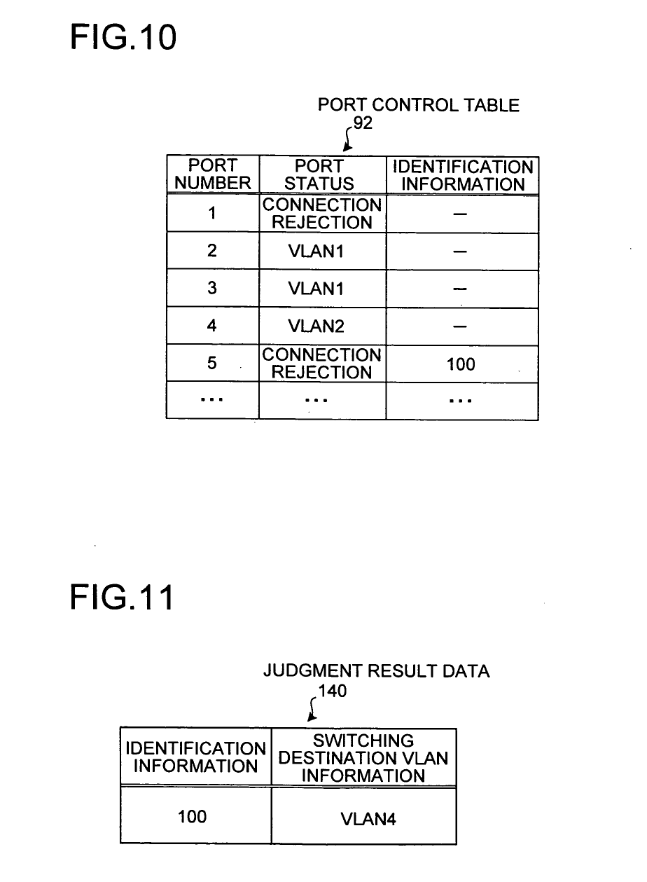

The port control table 92 is a table wherein information about the VLAN set to the respective communication ports of the switch 90 is registered. FIG. 10 is an example of the port control table 92 shown in FIG. 9.

As shown in FIG. 10, in this port control table 92, respective information pieces of port number, port status, and identification information are registered. The port number is an identification number that identifies the respective ports that the switch 90 has. The port status is VLAN information of the connection destination set to ports to which respective terminal devices are connected. By the way, in the default status before the control server device 30 judges the VLAN of the connection destination of the terminal device 80, the port status is set to “connection rejection”.

The identification information is information that identifies the port at which the security countermeasure level data is accepted from the terminal device 80. The identification information is generated at the moment when the security countermeasure level data is accepted from the terminal device 80, and is sent together with the security countermeasure level data to the control server device 100.

The connection control unit 93 is a control unit that refers to the port control table 92 when it receives data from the terminal device 80 to a terminal device or a server device connected to the VLAN 110, and thereby judges the connection propriety to the VLAN 110.

Concretely, the connection control unit 93 permits the connection to the VLAN 110 when the port status corresponding to the port that has received data is set to the VLAN 110 in the port control table 92, and sends the data to the port corresponding to the VLAN 110. While, when the port status corresponding to the port that has received the data is set to the update VLAN 120, the connection control unit rejects the connection to the VLAN 110, and sets the port so that communications should be made only with the update VLAN 120.

The connection control unit 93 sends the security countermeasure level transfer data wherein identification information is added to the security countermeasure level data, to the control server device 100, and when it receives the identification information from the control server device 100 and judgment result data showing the judgment result of the VLAN to which the terminal device 80 is connected, in response thereto, it carries out a process to set the port status of the port corresponding to the identification information concerned in the port control table 92.

FIG. 11 is an example of the judgment result data 140 that is sent by the control server device 100. As shown in FIG. 11, this judgment result data 140 includes identification information and switching destination VLAN information. The identification information is the information that identifies ports of the switch 90, and the switching destination VLAN information is the information of the VLAN to which the terminal device 80 is connected, judged by the control server device 100.

Back to the explanation of FIG. 9, the control unit 94 is a control unit that entirely controls the terminal device 90, and sends and receives data with the respective functional units.

The control server device 100 is a server device that receives the security countermeasure level transfer data from the switch 90, and judges which VLAN the terminal device 80 should be connected to, on the basis of the security countermeasure level data included in the security countermeasure level transfer data.

The control server device 100 includes a communication processing unit 101, connection condition data 102, a connection destination VLAN judgment unit 103 and a control unit 104. The communication processing unit 101 is a communication processing unit that communicates with the switch 90, and receives the security countermeasure level transfer data sent from the switch 90, and sends out judgment result data 140 to the switch 90.

The connection condition data 102 is data that is referred to at the moment of judgment the VLAN to which the terminal device 80 is connected, and memorizes the conditions to decide the connection destination VLAN.

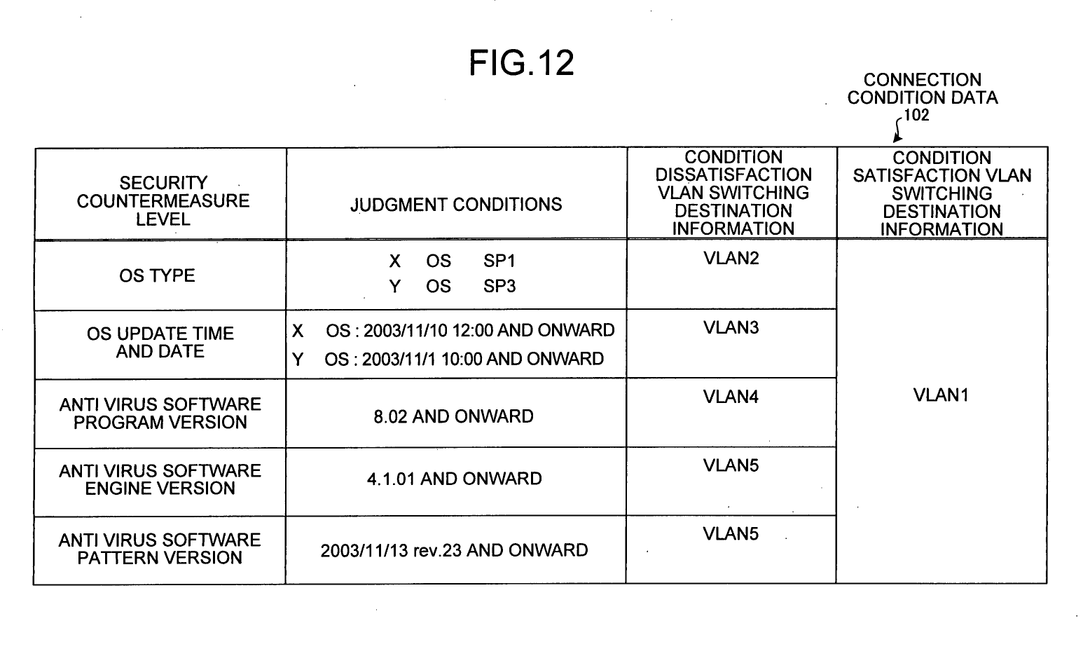

FIG. 12 is an example of the connection condition data 102 shown in FIG. 9. As shown in FIG. 12, in this connection condition data 102, respective information pieces of security countermeasure level, judgment conditions, condition dissatisfaction VLAN switching destination information, and condition satisfaction VLAN switching destination information are registered.

The security countermeasure level includes respective items selected to judge the conditions of computer virus countermeasures, which correspond to the respective items included in the security countermeasure level data that is sent by the terminal device 80. The judgment conditions are conditions that the respective items registered in the security countermeasure level should satisfy.

The condition dissatisfaction VLAN switching destination information is information of the update VALN 120 that is to be set as the switching destination VLAN, when the respective items included in the security countermeasure level data are not satisfied. The condition satisfaction VLAN switching destination information is information of the VLAN 110 that is to be connected, when the respective items included in the security countermeasure level data are satisfied.

Back to the explanation of FIG. 9, the connection destination VLAN judgment unit 103 judges whether the respective items of the security countermeasure level data included in the security countermeasure level transfer data that the communication processing unit 101 receives satisfy the respective judgment conditions memorized in the connection condition data 102 or not, and generates the judgment result data 140 shown in FIG. 11, and carries out a process to send the judgment result data via the communication processing unit 101 to the switch 90.

The control unit 104 is a control unit that entirely controls the control server device 100, and sends and receives data with the respective functional units.

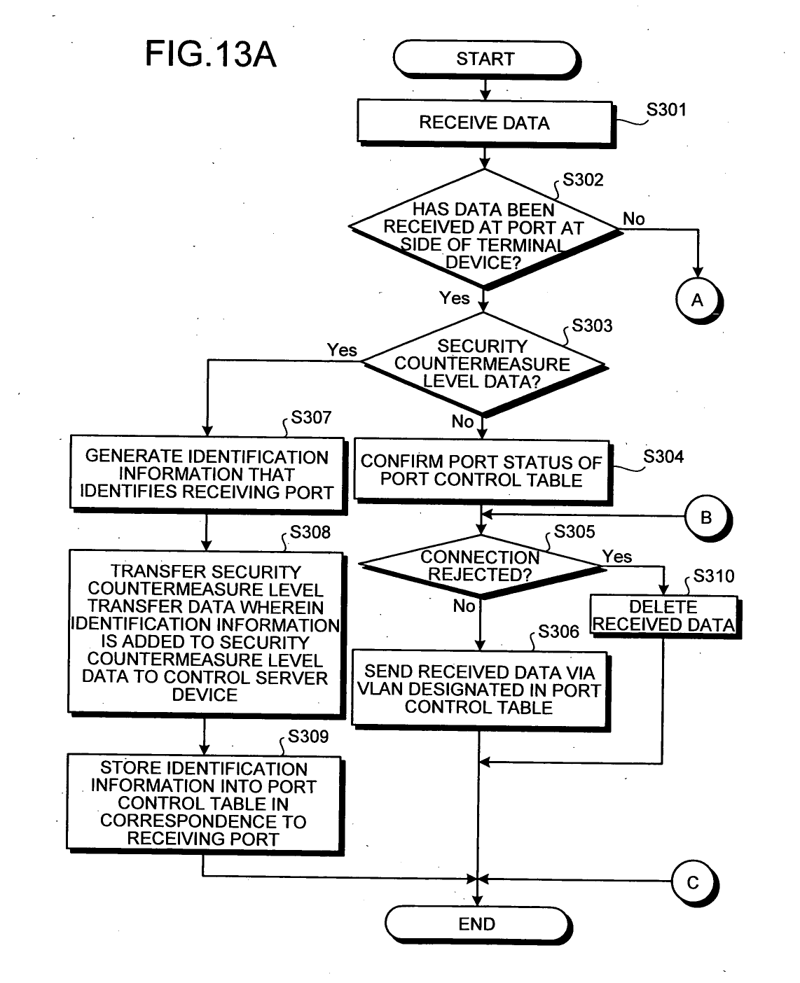

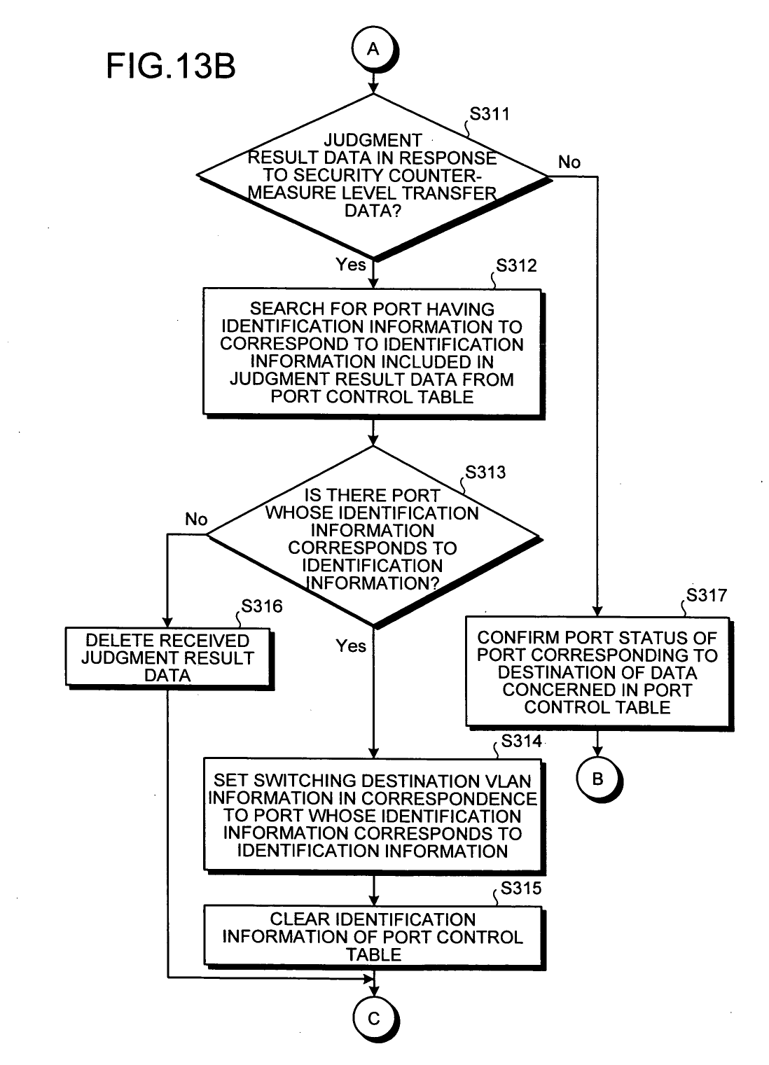

The process procedure of the connection control process that the switch 90 according to the second embodiment conducts is explained hereinafter. FIG. 13A and FIG. 13B are flow charts (1) and (2) respectively showing the process procedure of the connection control process that the switch 90 according to the second embodiment conducts.

As shown in FIG. 13A, first, the communication processing unit 91 of the switch 90 receives data (step S301). The communication processing unit 91 judges whether the data has been received at the port at the side of the terminal device 80 or not (step S302), and when the data has been received at the port at the side of the terminal device 80 (step S302, Yes), the communication processing unit 91 checks whether the received data is the security countermeasure level data or not (step S303).

When the received data is not the security countermeasure level data (step S303, No), the connection control unit 93 confirms the port status corresponding to the port that has received the data in reference to the port control table 92 (step S304), and checks whether the port status is “connection rejection” or not (step S305).

When the port status is not “connection rejection” (step S305, No), the connection control unit 93 sends the received data via the VLAN designated in the port control table 92 (step S306), and completes the connection control process. When the port status is “connection rejection” (step S305, Yes), the connection control unit 93 deletes the data received from the terminal device 80 (step S310), and completes the connection control process.

In the step S303, when the data received from the terminal device 80 is the security countermeasure level data (step S303, Yes), the communication processing unit 91 generates identification information that identifies the port that has received the data (step S307), and transfers the security countermeasure level transfer data wherein the identification information is added to the security countermeasure level data to the control server device 100 (step S308).

Then, the communication processing unit 91 stores the identification information into the port control table 92 in correspondence to the port that has received the data (step S309), and completes the connection control process.

In the step S302, when the data has not been received at the port at the side of the terminal device 80, but received at the port at the side of the control server device 100 (step S302, No), as shown in FIG. 13B, the communication processing unit 91 checks whether the received data is the judgment result data 140 that is sent in response to the security countermeasure level transfer data sent to the control server device 100 or not (step S311).

When the received data is the judgment result data 140 (step S311, Yes), the connection control unit 93 searches for a port having identification information to correspond to the identification information included in the judgment result data 140 from the port control table 92 (step S312), and checks whether there is a port whose identification information corresponds to the identification information included in the judgment result data or not (step S313).

When there is a port whose identification information corresponds to the identification information included in the judgment result data (step S313, Yes), the connection control unit 93 sets the switching destination VLAN information to the port status in correspondence to the port whose identification information corresponds to the identification information included in the judgment result data (step S314), and clears the identification information of the port control table 92 (step S315), and completes the connection control process. When there is not any port whose identification information corresponds to the identification information included in the judgment result data (step S313, No), the connection control unit 93 deletes the received judgment result data 140 (step S316), and completes the connection control process.

In the step S311, when the received data is not the judgment result data 140 (step S311, No), the connection control portion 93 confirms the port status of the port corresponding to the destination of the data concerned in the port control table 92 (step S317), and as shown in FIG. 13A, checks whether the port status is “connection rejection” or not (step S305).

When the port status is not “connection rejection” (step S305, No), the connection control unit 93 sends the received data via the VLAN designated by the port control table 92 (step S306), and completes the connection control process. When the port status is “connection rejection” (step S305, Yes), the connection control unit 93 deletes the data received from the control server device 100 (step S310), and completes the connection control process.

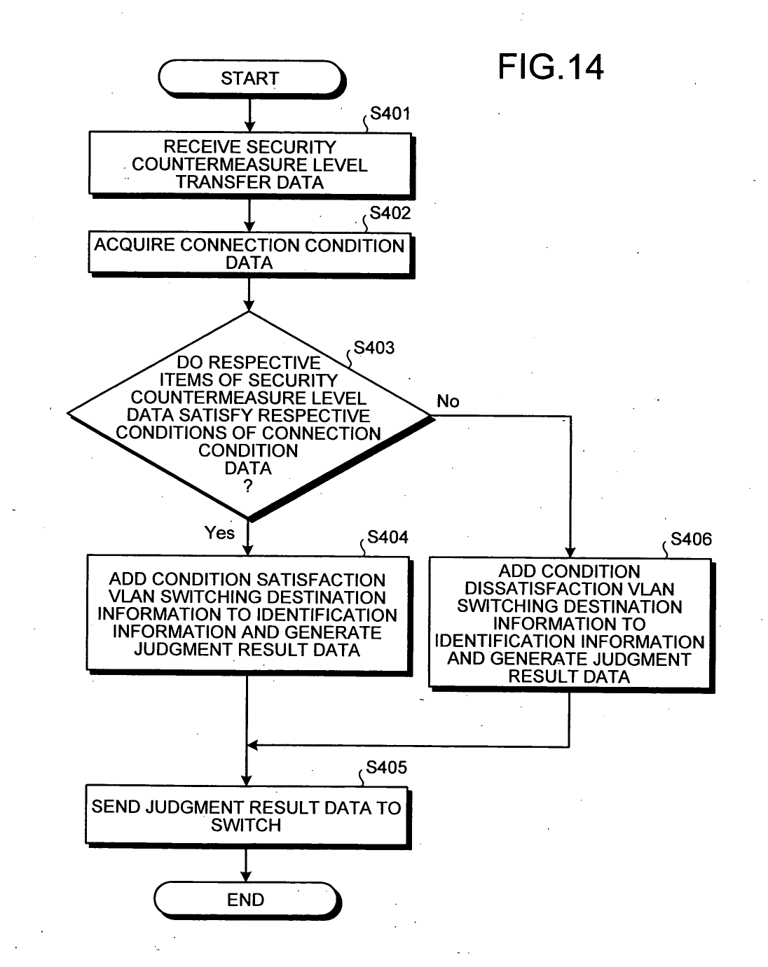

The process procedure of the switching destination VLAN judgment process that the control server device 100 according to the second embodiment performs is explained hereinafter. FIG. 14 is a flow chart of the process procedure of the switching destination VLAN judgment process that the control server device 100 according to the second embodiment performs.

As shown in FIG. 14, first, the communication processing unit 101 of the control server device 100 receives the security countermeasure level transfer data that is sent by the switch 90 (step S401). The connection destination VLAN judgment unit 103 acquires the connection condition data 102 (step S402), and checks whether the respective items of the security countermeasure level data included in the received security countermeasure level transfer data satisfy the respective conditions of the connection condition data 102 or not (step S403).

When the respective items of the security countermeasure level data included in the received security countermeasure level transfer data satisfy the respective conditions of the connection condition data 102 (step S403, Yes), the connection destination VLAN judgment unit 103 adds the condition satisfaction VLAN switching destination information to the identification information and thereby generates judgment result data 140 (step S404). Then, the communication processing unit 101 sends the judgment result data 140 generated by the connection destination VLAN judgment unit 103 to the switch 90 (step S405).

When the respective items of the security countermeasure level data included in the received security countermeasure level transfer data do not satisfy the respective conditions of the connection condition data 102 (step S403, No), the connection destination VLAN judgment unit 103 adds the condition dissatisfaction VLAN switching destination information to the identification information and thereby generates judgment result data 140 (step S406). Then, the communication processing unit 101 sends the judgment result data 140 generated by the connection destination VLAN judgment unit 103 to the switch 90 (step S405).

By the way, in the second embodiment, a case wherein a common update VLAN 120 is allotted to respective terminal devices whose security countermeasures are insufficient, while in place of this, an individual update VLAN may be allotted to each of terminal devices.

Further, in combination with the first embodiment, the process to connect the terminal device to the network and the process to reject the connection, and the process to limit the VLAN that permits the connection may be employed in combination.

As mentioned above, in the second embodiment, when the network is logically divided as a VLAN, the communication processing unit 91 of the switch 90 receives the information of the VLAN 110 or the update VLAN 120, to which the terminal device 80 is connected, judged by the control server device 100 on the basis of the security countermeasure level data of the terminal device 80, and the communication processing unit 93 of the switch 90, on the basis of the received information, limits the VLAN that permits the terminal device 80 to connect to the VLAN 110 or the update VLAN 120, accordingly, the second embodiment makes it possible to appropriately prevent a computer virus from infecting from the terminal device 80 whose security countermeasures are insufficient to other terminal devices or server devices connected to the VLAN 110.

By the way, in the second embodiment, the connection destination of the terminal device in the network is limited by designating the VLAN, while in place of this, by designating IP address and port number and the like of a terminal device or a server device at destination with which communications are made, filtering may be made, and thereby the connection of the terminal device to network may be limited.

Concretely, when security countermeasures of a terminal device are insufficient, by restricting addresses and port numbers so that the terminal device can carry out communications only with the update server device that can update an OS and an anti virus software program, even if the terminal device is infected by a computer virus, the system makes it possible to prevent the infection from spreading over other devices connected to the network. Therefore, in a third embodiment, a case wherein the switch carries out filtering by use of IP address and thereby controls the connection is explained hereinafter.

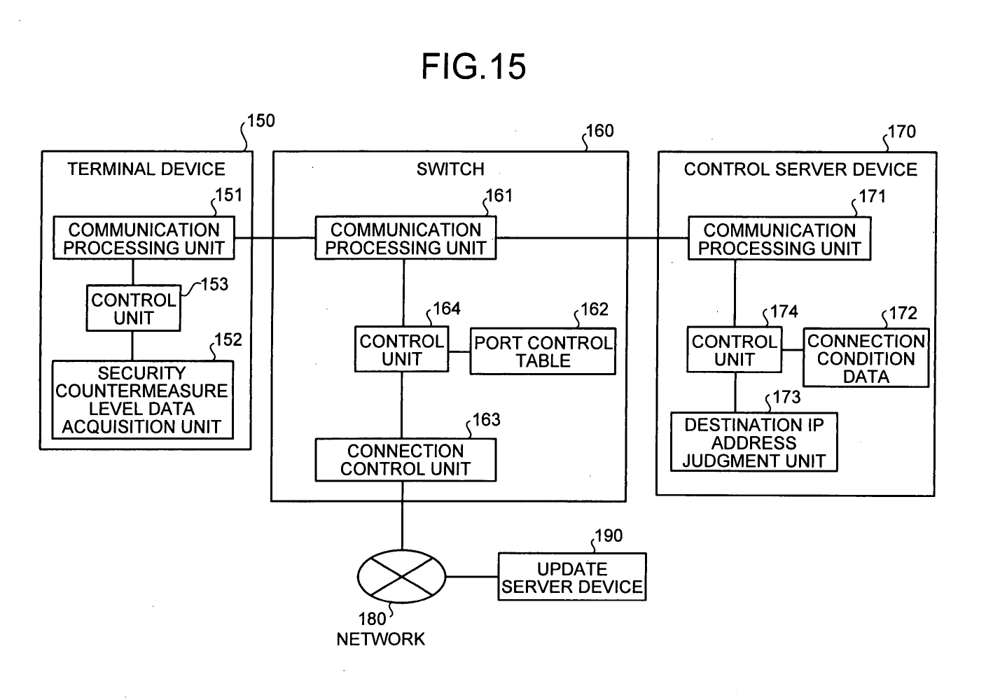

In the first place, the structure of a network connection control system according to the third embodiment is explained hereinafter. FIG. 15 is a functional block diagram of a network connection control system according to the third embodiment. By the way, detailed explanations about the functional units similar to those in the first embodiment shown in FIG. 1 are omitted hereinafter.

As shown in FIG. 15, in this network connection control system, a terminal device 150 and a switch 160 are connected with each other, and the switch 160 and a control server device 170 are connected with each other, and the switch 160 is connected to a network 180 to which plural terminal devices and server devices (not shown) are connected.

The terminal device 150 is a terminal device such as a personal computer to which various application software programs are installed, and a communication processing unit 151, a security countermeasure level data acquisition unit 152 and a control unit 153 equipped in the terminal device 150 have the functions similar to those of the communication processing unit 11, the security countermeasure level data acquisition unit 12 and the control unit 13 shown in FIG. 1.

The switch 160 is a network device that relays data received from the terminal device 150, and sends data to a port to which a terminal device or a server device at destination is connected via the network 180.

The switch 160 not only relays data, but also, when it receives the security countermeasure level data from the terminal device 150, it transfers the received security countermeasure level data to the control server device 170. The control server device 170 judges an IP address at communication destination that allows the terminal device 150 to communicate, on the basis of the sent security countermeasure level data.

The switch 160 receives the judgment result that is sent by the control server device 170, and memorizes the IP address information in correspondence with the port to which the terminal device 150 is connected. When the data is sent by the terminal device 150, on the basis of the memorized IP address information, the switch 160 carries out a process to connect the terminal device 150 to the network 180 or a process to reject the connection.

The switch 160 includes a communication processing unit 161, a port control table 162, a connection control unit 163, and a control unit 164. The communication processing unit 161 is a communication processing unit that has the functions similar to those of the communication processing unit 21 shown in FIG. 1.

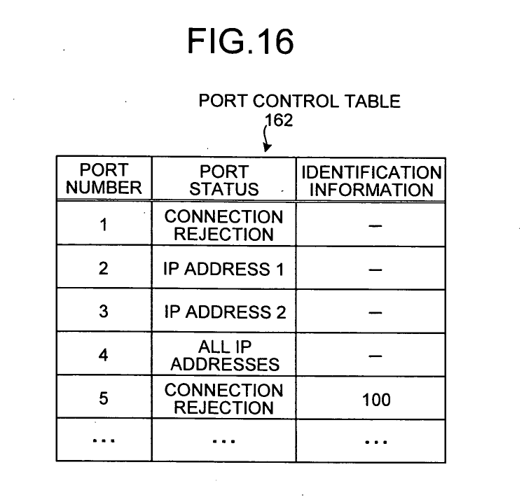

The port control table 162 is a table wherein information about the IP addresses set to the respective communication ports of the switch 160 is registered. FIG. 16 is an example of the port control table 162 shown in FIG. 15.

As shown in FIG. 16, in this port control table 162, respective information pieces of port number, port status, and identification information are registered. The port number is an identification number that identifies the respective ports that the switch has. The port status is IP address information of the connection destination set to ports to which respective terminal devices are connected. The identification information is information that identifies the port that has received the security countermeasure level data from the terminal device. The identification information is generated at the moment when the security countermeasure level data is accepted from the terminal device, and is sent together with the security countermeasure level data to the control server device 170.

Back to the explanation of FIG. 15, the connection control unit 163 is a control unit that refers to the port control table 162, when it receives data from the terminal device 150 to a terminal device or a server device connected to the network 180, and thereby limits the connection to the network 180.

Concretely, the connection control unit 163 checks the port status corresponding to the port that has received data, in the port control table 162, and when the IP address of the destination is included in the IP addresses registered in the port status, it connects to the network 180 and sends the data to the destination. When the port status corresponding to the port that has received the data is the IP address of the update server device 190, the connection control unit sets the port so that communications should be made only with the update server device 190.

The connection control unit 163 sends the security countermeasure level transfer data wherein identification information is added to the security countermeasure level data, to the control server device 170, and when it receives judgment result data showing the identification information and IP address judgment result from the control server device 170 in response thereto, the connection control unit carries out a process to set the IP address to the port status of the port corresponding to the identification information concerned in the port control table 162.

The control unit 164 is a control unit that entirely controls the switch 160, and sends and receives data with the respective functional units.

The control server device 170 is a server device that receives the security countermeasure level transfer data from the switch 160, and judges a terminal device or a server device connected to the network 180 that permits the connection of the terminal device 150 to the network 40, on the basis of the security countermeasure level data included in the security countermeasure level transfer data.

The control server device 170 includes a communication processing unit 171, connection condition data 172, a destination IP address judgment unit 173, and a control unit 174. The communication processing unit 171 is a communication processing unit that communicates with the switch 160, and receives the security countermeasure level transfer data that is sent from the switch 160, and sends out judgment result data to the switch 160.

The connection condition data 172 is data that is referred to at the moment of judgment of a terminal device or a server device to communicate with the terminal device 150, and memorizes the conditions to decide an IP address at connection destination.

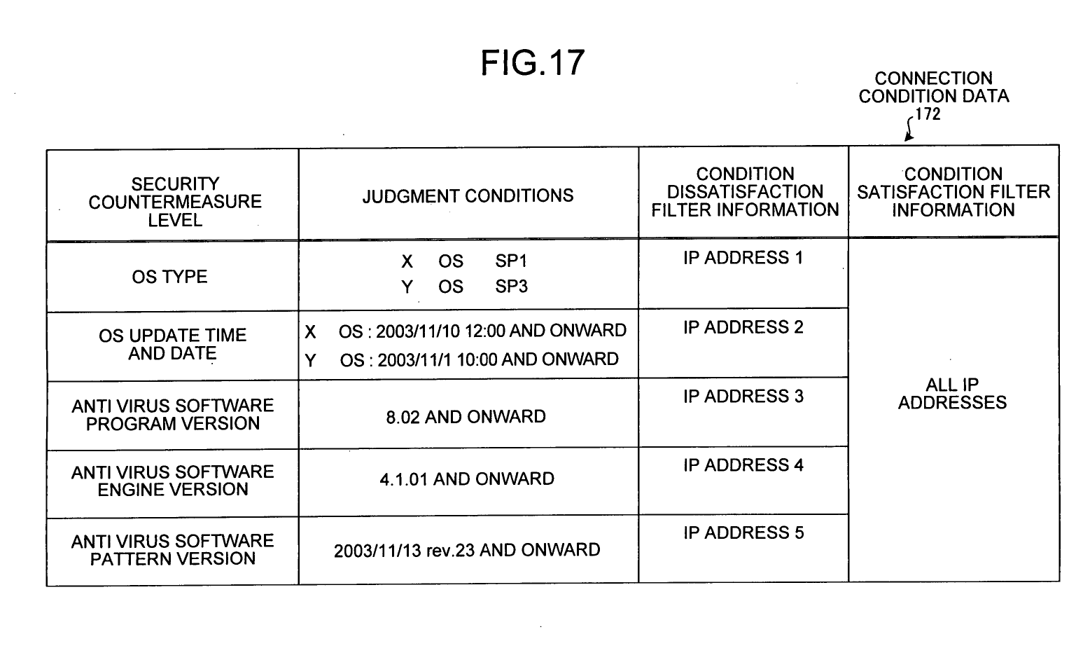

FIG. 17 is an example of the connection condition data 172 shown in FIG. 15. As shown in FIG. 17, in this connection condition data 172, respective information pieces of security countermeasure level, judgment conditions, condition dissatisfaction filter information, and condition satisfaction filter information are registered.

The security countermeasure level includes respective items selected to judge the conditions of computer virus countermeasures, which correspond, to the respective items included in the security countermeasure level data that is sent by the terminal device. The judgment conditions are conditions that the respective items registered in the security countermeasure level should satisfy.

The condition dissatisfaction filter information is information about the IP address of the update server device 190 that is to be connected when the respective items included in the security countermeasure level data are not satisfied. The condition satisfaction filter information is information about the IP address of the terminal device or server device that is to be connected when the respective items included in the security countermeasure level data are satisfied. Herein, the condition satisfaction filter information is the IP addresses of all the terminal devices or server devices connected to the network 180.

Back to the explanation of FIG. 15, the destination IP address judgment unit 173 judges whether the respective items of the security countermeasure level data included in the security countermeasure level transfer data that the communication processing unit 171 has received satisfy the respective judgment conditions memorized in the connection condition data 172 or not, and sends the judgment result thereof via the communication processing unit 171 to the switch 160.

The control unit 174 is a control unit that entirely controls the control server device 170, and sends and receives data with the respective functional units.

By the way, in the third embodiment, filtering is carried out by use of IP address and the like, while in place of this, as mentioned in the second embodiment, by combination of filtering and limitation of connectable VLAN, safety against virus infection may be further increased.

As mentioned above, in the third embodiment, the communication processing unit 161 of the switch 160 accepts the IP address limitation information of the terminal device 150, judged by the control server device 170 on the basis of the security countermeasure level data of the terminal device 150, and on the basis of the accepted information, the communication processing unit limits terminal devices or server devices at communication destination with which the terminal device 150 communicates, accordingly, the third embodiment makes it possible to appropriately prevent a computer virus from infecting from the terminal device 150 whose security countermeasures are insufficient to other terminal devices or server devices connected to the network 180.

By the way, in the second embodiment, when the security countermeasure level data is sent by the terminal device, the connection destination of the terminal device is allotted to the update VLAN, while in place of this, when the network cable of the terminal device is connected to the port of the switch, the switch may connect the terminal device first to a confirmation update VLAN wherein the security countermeasure level of the terminal device can be confirmed and updated.

Thereby, even if the terminal device is infected by a computer virus, the system makes it possible to prevent the infection from spreading over other devices connected to the network. Further, the system makes it possible to prevent the terminal device from being infected by a computer virus from other devices during the terminal device is updating an OS or an anti virus software program. Therefore, in a fourth embodiment, a case wherein when the network cable of the terminal device is connected to the port of the switch, the switch first connects the terminal device to a confirmation update VLAN is explained hereinafter.

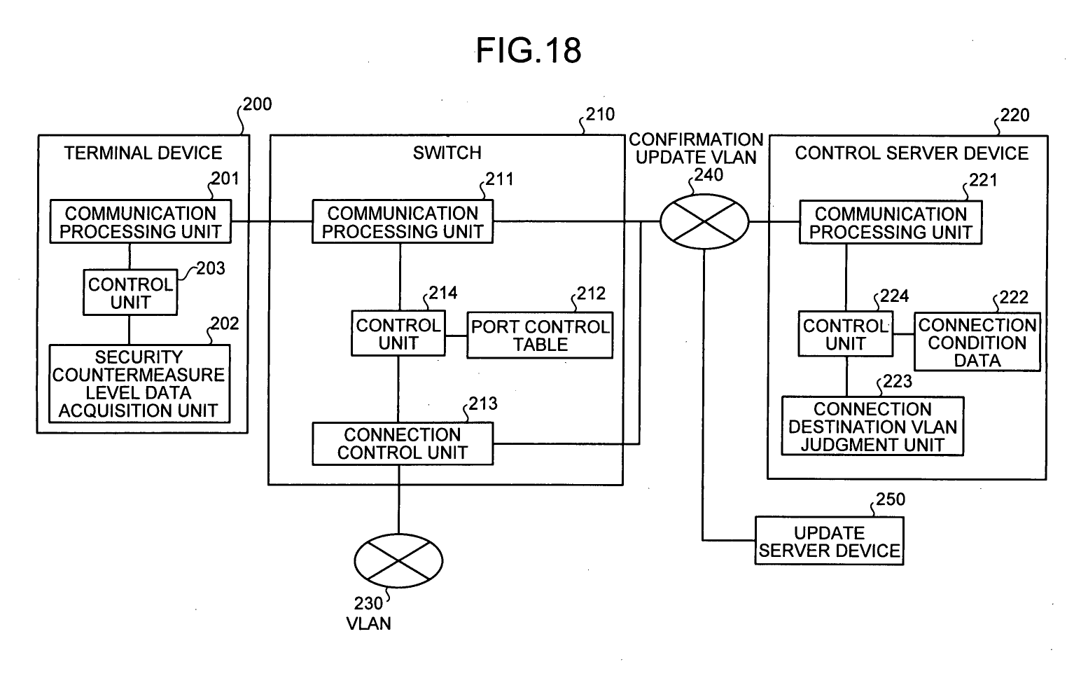

In the first place, the structure of a network connection control system according to the fourth embodiment is explained hereinafter. FIG. 18 is a functional block diagram of a network connection control system according to the fourth embodiment. By the way, detailed explanations about the functional units similar to the functional units in the second embodiment shown in FIG. 9 are omitted hereinafter.

As shown in FIG. 18, in this network connection control system, a terminal device 200 and a switch 210 are connected with each other, and the switch 210 and a control server device 220 and an update server device 250 are connected via a confirmation update VLAN 240, and the switch 210 is connected to a VLAN 230.

The confirmation update VLAN 240 is a VLAN wherein the control server device 220, and the update server device 250 that enables the terminal device 200 to update an OS or an anti virus software program are connected, while the VLAN 230 is a VALN that is used when the terminal device 200 carries out communications with other terminal devices or server devices (not shown).

The terminal device 200 is a terminal device such as a personal computer to which various application software programs are installed, and a communication processing unit 201, a security countermeasure level data acquisition unit 202 and a control unit 203 equipped in the terminal device 200 have the functions similar to those of the communication processing unit 81, the security countermeasure level data acquisition unit 82 and the control unit 83 shown in FIG. 9.

The switch 210 is a network device that relays data received from the terminal device 200, and sends data to a port to which a terminal device or a server device at destination is connected via the VLAN 230.

The switch 210 not only relays data, but also, when the terminal device 200 is connected to the switch 210, it carries out a process to connect the confirmation update VLAN 240 that enables to confirm and update the security countermeasure level of the terminal device 200.

When this switch 210 receives the security countermeasure level data from the terminal device 200, it transfers the received security countermeasure level data to the control server device 220. The control server device 220 judges the VLAN to which the terminal device 200 should be connected, on the basis of the sent security countermeasure level data.

Then, the switch 210 receives the judgment result that is sent by the control server device 220, and memorizes the VLAN information in correspondence with the port to which the terminal device 200 is connected. When the data is sent by the terminal device 200, on the basis of the memorized VLAN address information, the switch 210 carries out a process whether to keep the terminal device 200 connected to the confirmation update VLAN 240, or to switch the terminal device to the VLAN 230 as the connection destination thereof.

The switch 210 includes a communication processing unit 211, a port control table 212, a connection control unit 213, and a control unit 214. The communication processing unit 211 is a communication processing unit that communicates with the terminal device 200 and the control server device 220. A process to relay communications among the terminal device 200 and terminal devices or server devices (not shown) connected to the VLAN 230 is carried out.

Concretely, when the network cable of the terminal device 200 is connected to the port of the switch 210, this communication processing unit 211 connects the terminal device 200 to the confirmation update VLAN 240.

The communication processing unit accepts the data that is sent by the terminal device 200, and when the accepted data is the security countermeasure level data, the communication processing unit adds the information of the port that has accepted the data to the security countermeasure level data, and transfers the data to the control server device 220. When the data accepted from the terminal device 200 is other data than the security countermeasure level data, the communication processing unit transfers the data to the connection control unit 213.

The port control table 212 is a table similar to the port control table 92 shown in FIG. 10.

The connection control unit 213 is a control unit that refers to the port control table 212 when it receives data from the terminal device 200 to a terminal device or a server device connected to the VLAN 230, and thereby judges the connection propriety to the VLAN 230.

Concretely, the connection control unit 213 permits the connection to the VLAN 230 when the port status corresponding to the port that has received data is set to the VLAN 230 in the port control table 212, and sends the data to the port corresponding to the VLAN 230. While it rejects the connection to the VLAN 230, and set the port so that communications should be made only with the update VLAN 240 when the port status corresponding to the port that has received the data is set to the update VLAN 240.

The connection control unit 213 sends the security countermeasure level transfer data wherein identification information is added to the security countermeasure level data, to the control server device 220, and when it receives the identification information from the control server device 220 and judgment result data showing the judgment result of the VLAN to which the terminal device 200 is to be connected, in response thereto, it carries out a process to set the port status of the port corresponding to the identification information concerned in the port control table 212.

The control server device 220 is a server unit that receives the security countermeasure level transfer data from the switch 210, and judges which VLAN the terminal device 200 should be connected to, on the basis of the security countermeasure level data included in the security countermeasure level transfer data.

A communication processing unit 221, connection condition data 222, a connection destination VLAN judgment unit 223 and a control unit 224 equipped in the control server device 220 have the functions similar to those of the communication processing unit 101, the connection condition data 102, the connection destination VLAN judgment unit 103 and the control unit 104 shown in FIG. 9.

However, in the condition dissatisfaction VLAN switching destination information of the connection condition data 222, the information of the confirmation update VLAN 240 is registered, therefore, only when the respective conditions of the connection condition data 222 are satisfied, the connection is made to other VLAN registered in the condition satisfaction VLAN switching destination information, namely, the VLAN 230.

As mentioned above, in the fourth embodiment, when the terminal device 200 is connected to the switch 210, the communication processing unit 211 of the switch 210 connects the terminal device 200 to the confirmation update VLAN 240 that can confirm and update the security countermeasure level of the terminal device 200, accordingly, the fourth embodiment makes it possible to appropriately prevent a computer virus from infecting from the terminal device 200 whose security countermeasures are insufficient to other terminal devices or server devices connected to the VLAN 230.

By the way, in the first embodiment through the fourth embodiment, when the security countermeasure level of the terminal device is checked, authentication process to a user is not performed, while, security may be further improved by use of user authentication. Therefore, in a fifth embodiment, a case wherein user authentication is performed when the security countermeasure level of the terminal device is confirmed is explained hereinafter.

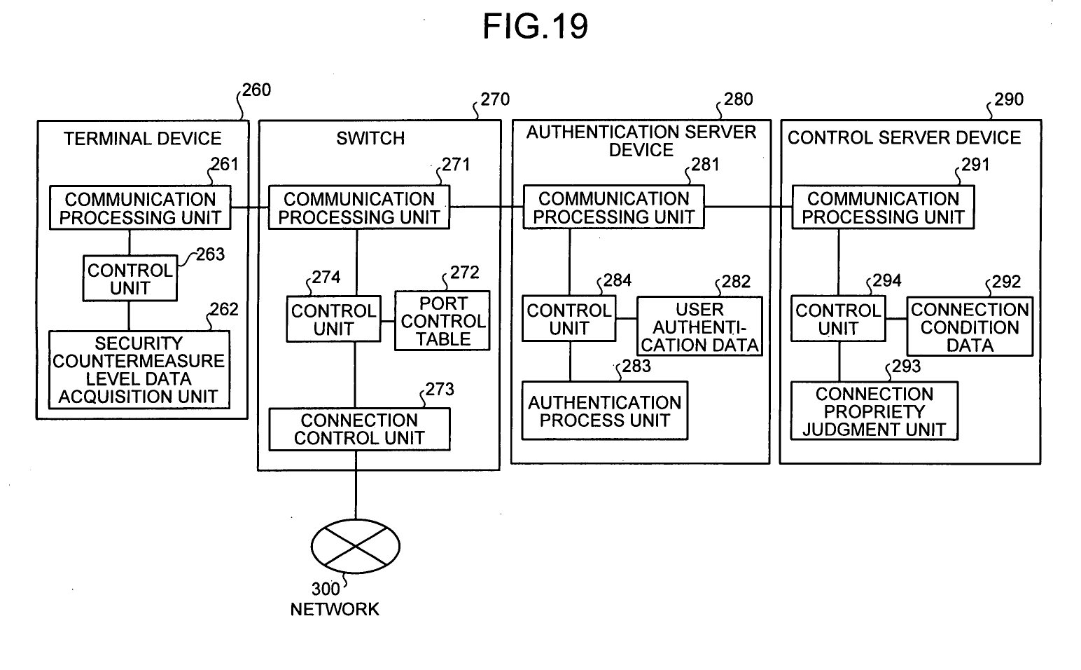

In the first place, the structure of a network connection control system according to the fifth embodiment is explained hereinafter. FIG. 19 is a functional block diagram of a network connection control system according to the fifth embodiment. By the way, detailed explanations about the similar functional units to the functional units in the first embodiment shown in FIG. 1 are omitted hereinafter.

As shown in FIG. 19, in this network connection control system, a terminal device 260 and a switch 270 are connected with each other, and the switch 270 and a control server device 280 are connected with each other, and an authentication server device 280 and a control server device 290 are connected with each other, and the switch 270 is connected to a network 300 to which plural terminal devices and server devices (not shown) are connected.

The terminal device 260 is a terminal device such as a personal computer to which various application software programs are installed. The terminal device 260 includes a communication processing unit 261, a security countermeasure level data acquisition unit 262 and a control unit 263.

The communication processing unit 261 is a communication processing unit that carries out communications with other connected terminal devices, server devices, the switch 270 and the like via the network. The security countermeasure level data acquisition unit 262 is an acquisition unit that acquires the computer virus countermeasure conditions of the terminal device 260 as security countermeasure level data. The acquired security countermeasure level data is sent by the communication processing unit 261 to the switch 270. At this moment, the communication processing unit 261 sends the security countermeasure level data including user authentication information to the switch 270.

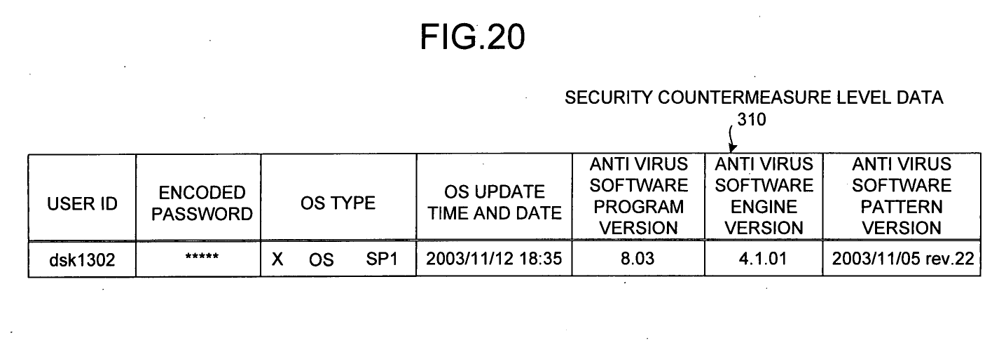

FIG. 20 is an example of security countermeasure level data 310 that the terminal device 260 sends. As shown in FIG. 20, this security countermeasure level data 310 includes information pieces of OS (Operating System) type, OS update time and date, anti virus software program version, anti virus software engine version, and anti virus software pattern version.

Back to the explanation of FIG. 19, the control unit 263 is a control unit that entirely controls the terminal device 260, and sends and receives data with the respective functional units.

The switch 270 is a network device that relays the data received from the terminal device 260, and sends the data to a port to which a terminal device or a server device at destination is connected via a network.

The switch 270 not only relays data, but also, when it receives the security countermeasure level data 310 from the terminal device 260, it carries out a process to transfer the security countermeasure level data 310 to the authentication server device 280.

The authentication server device 280 carries out user authentication, and only when the authentication is successful, it transfers the security countermeasure level data 310 to the control server device 290, and the control server device 290 judges connection propriety of the terminal device 260 to the network 300, on the basis of the security countermeasure level data 310. When the authentication fails, the authentication server device 280 sends authentication failure information to the switch 270.

When the switch 270 receives the data showing the connection propriety to the network 300 judged by the control server device 290, it memorizes the data in correspondence to the port to which the terminal device 260 is connected. When the data is sent by the terminal device 260, the switch carries out a process to connect the terminal device 260 to the network 300 or reject the connection, on the basis of the memorized connection propriety information. When the switch accepts authentication failure information by the authentication server device 280, it memorizes “connection rejection” information in correspondence to the port to which the terminal device 260 is connected.

The switch 270 includes a communication processing unit 271, a port control table 272, a connection control unit 273, and a control unit 274. The communication processing unit 271 is a communication processing unit that communicates with the terminal device 260 and the authentication server device 280. The communication processing unit also carries out a process to relay communications with a terminal device or a server device connected to the terminal device 260 and the network 300.

Concretely, when the data accepted from the terminal device 260 is the security countermeasure level data 310, this communication processing unit 271 generates security countermeasure level transfer data wherein the information of the port that has accepted the data is added to the security countermeasure level data 310, and transfers that data to the authentication server device 280. While, when the data accepted from the terminal device 260 is other data than the security countermeasure level data 310, the communication processing unit transfers that data to the connection control unit 273.

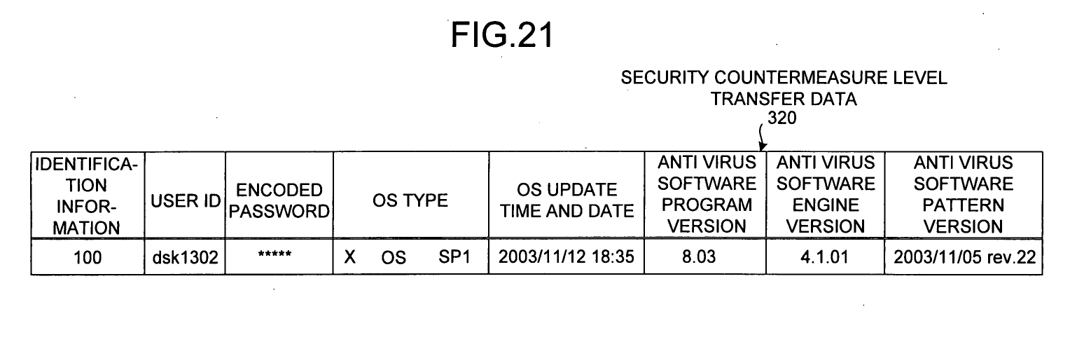

FIG. 21 is an example of security countermeasure level transfer data 320 that the switch 270 sends. As shown in FIG. 21, this security countermeasure level transfer data 320 includes information pieces of identification information, user ID, encoded password, OS (Operating System) type, OS update time and date, anti virus software program version, anti virus software engine version, and anti virus software pattern version.

The identification information is an identification number that identifies the port at which the switch 270 accepts the data from the terminal device 260, while the user ID, the encoded password, the OS (Operating System) type, the OS update time and date, the anti virus software program version, the anti virus software engine version, and the anti virus software pattern version are the respective information pieces included in the security countermeasure level data 310.

Back to the explanation of FIG. 19, the port control table 272 is a table wherein the information about the communication permission or rejection set to each communication port of the switch 270 is registered, and is a table similar to the port control table 22 shown in FIG. 4.

The connection control unit 273 is a control unit that refers to the port control table 272 when it receives data from the terminal device 260 to a terminal device or a server device connected to the network 300, and thereby controls the connection of the terminal device 260 to the network 300.

Concretely, the connection control unit 273 rejects data communications when the port status corresponding to the port that has received the data is set to “connection rejection” in the port control table 272, while it permits data communications, and carries out a process to send data to the port to which the terminal device or the server device at communication destination is connected when the port status is set to “connection permission”.

The connection control unit 273 sends the security countermeasure level transfer data 320 wherein identification information is added to the security countermeasure level data 310, to the authentication server device 280, and when it receives authentication judgment result data from the authentication control server device 280 in response thereto, it carries out a process to set the port status in the port control table 272.

Concretely, when the authentication result information included in the authentication judgment result data is “authentication success”, the connection control unit sets the port status of the port control table 272 on the basis of the connection propriety judgment result judged by the control server device 290 included in the authentication judgment result data. When the authentication result information is “authentication failure”, the connection control unit sets the port status of the port control table 272 to “connection rejection”.

The control unit 274 is a control unit that entirely controls the switch 270, and sends and receives data with the respective functional units.

The authentication server device 280 is a server device such as an RADIUS (Remote Authentication Dial-In User Services) server that accepts the security countermeasure level transfer data 320 including user authentication information from the switch 270, and thereby carries out user authentication. The authentication server device 280, when user authentication succeeds, transfers the security countermeasure level data wherein user authentication information is deleted from the security countermeasure level transfer data 320, to the control server device 290.

The authentication server 280 includes a communication processing unit 281, user authentication data 282, an authentication process unit 283, and a control unit 284. The communication processing unit 281 is a processing unit that performs communications with the switch 270 and the control server device 290.

Concretely, this communication processing unit 281 accepts the security countermeasure level transfer data 320 from the switch 270, and acquires the authentication information included in the security countermeasure level transfer data 320, and informs the authentication process unit 283 of the authentication information. When the user authentication by the authentication process unit 283 succeeds, this communication processing unit 281 sends to the control server device 290 the security countermeasure data wherein the user authentication information is deleted from the security countermeasure level transfer data 320.

Then, when this communication processing unit 281 accepts, on the basis of the security countermeasure level data sent to the control server device 290, the judgment result information wherein the connection propriety of the terminal device 260 to the network 300 is judged by the control server device 290, together with the port identification information, the communication processing unit sends authentication judgment result data wherein further authentication success information is added to the above information pieces to the switch 270.

When the user authentication fails, the communication processing unit 281 sends authentication judgment result data including the port identification information and the authentication failure information to the switch 270.

The user authentication data 282 is data wherein user authentication information is registered, and is referred to when the authentication process unit 283 carries out user authentication. The authentication process unit 283 accepts the authentication information included in the security countermeasure level transfer data 320 by the communication processing unit 281, and when the authentication information is same as the authentication information registered in the user authentication data 282, the authentication process unit judges that the user authentication has succeeded, and instructs the communication processing unit 281 to send the security countermeasure level data to the control server device 290.

The control server device 290 is a device that receives the security countermeasure level data from the authentication server device 280, and judges whether or not to permit the connection of the terminal device 260 to the network 300, on the basis of the security countermeasure level.

The control server device 290 includes a communication processing unit 291, communication condition data 292, a connection propriety judgment unit 293 and a control unit 294. The communication processing unit 291 is a communication processing unit that communicates with the authentication server device 280, and receives the security countermeasure level data sent from the authentication server device 280, and sends out judgment result data wherein whether or not to permit the connection of the terminal device 260 to the network 300 is judged to the authentication server device 280.

The communication condition data 292 is data that is referred to when whether or not to connect the terminal device 260 to the network 300 is judged, and conditions to decide connection propriety is memorized therein. Concretely, the communication condition data is data similar to the connection condition data 32 shown in FIG. 6.

The connection propriety judgment unit 293 judges whether the respective items of the security countermeasure level data that the communication processing unit 291 has received satisfy the respective judgment conditions memorized in the connection condition data 292 or not, and generates the judgment result data similar to the judgment result data 70 shown in FIG. 5, and carries out a process to send the judgment result data via the communication processing unit 291 to the authentication server device 280.

The control unit 294 is a control unit that entirely controls the control server device 290, and sends and receives data with the respective functional units.

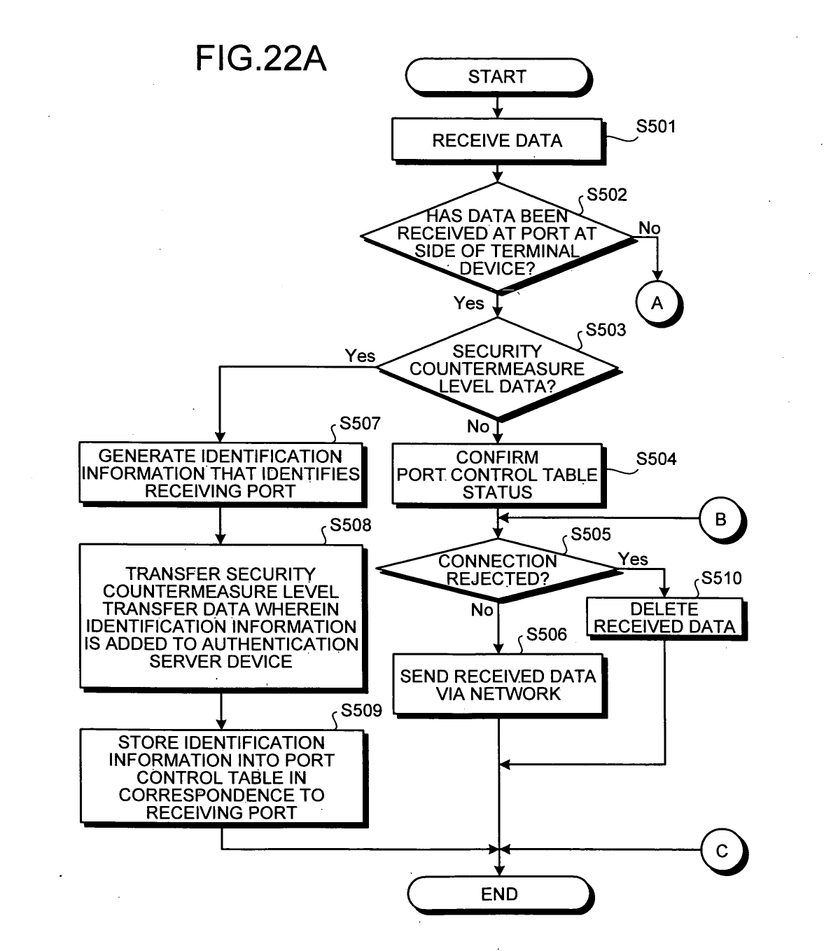

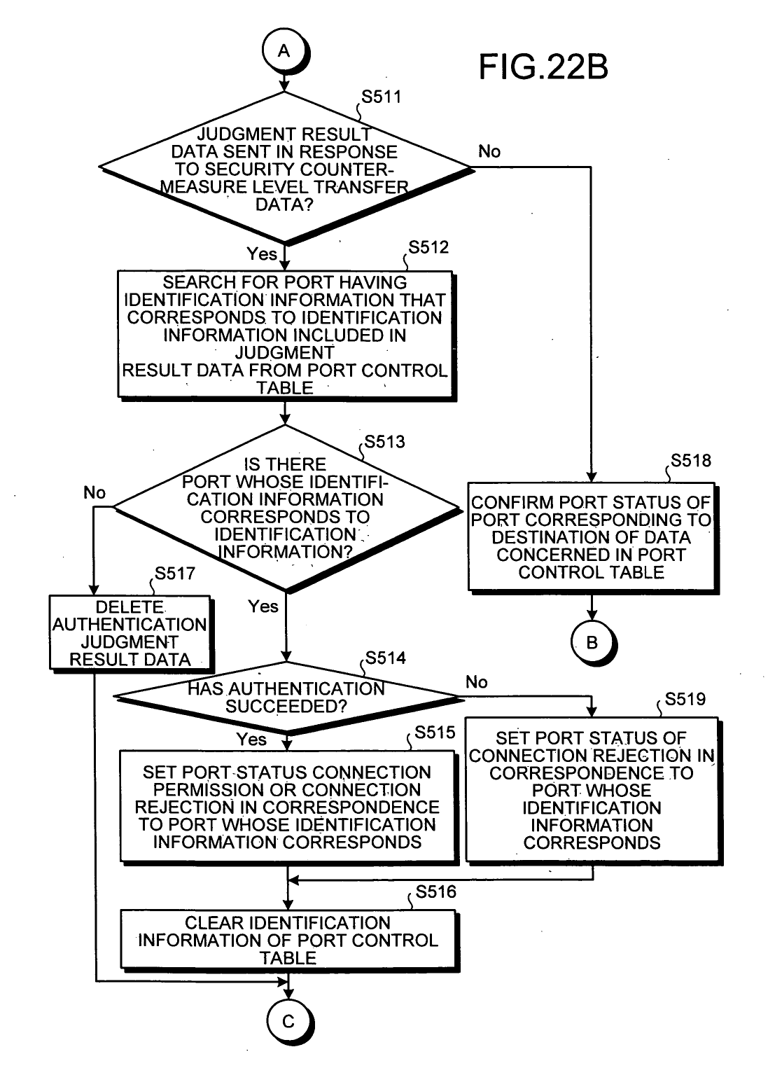

The process procedure of the connection control process that the switch 270 according to the fifth embodiment performs are explained hereinafter. FIG. 22A and FIG. 22B are flow charts (1) and (2) respectively showing the process procedure of the connection control process that the switch 270 according to the fifth embodiment conducts.

As shown in FIG. 22A, first, the communication processing unit 271 of the switch 270 receives data (step S501). The communication processing unit 271 judges whether the data has be received at the port at the side of the terminal device 260 or not (step S502), and when the data has been received at the port at the side of the terminal device 260 (step S502, Yes), the communication processing unit checks whether the received data is the security countermeasure level data 310 or not (step S503).

When the received data is not the security countermeasure level data 310 (step S503, No), the connection control unit 273 refers to the port control table 272 and confirms the port status corresponding to the port that has received the data (step S504), and checks whether the port status is “connection rejection” or not (step S505).

When the port status is not “connection rejection” (step S505, No), the connection control unit 273 sends the received data via the network 300 to a terminal device or a server device at destination (step S506), and completes the connection control process. When the port status is “connection rejection” (step S505, Yes), the connection control unit 273 deletes the data received from the terminal device 260 (step S510), and completes the connection control process.

In the step S503, when the data received from the terminal device 260 is the security countermeasure level data 310 (step S503, Yes), the communication processing unit 271 generates identification information that identifies the port that has received the data (step S507), and transfers the security countermeasure level transfer data 320 wherein the identification information is added to the security countermeasure level data 310 to the authentication server device 280 (step S508).

Then, the communication processing unit 271 stores the identification information into the port control table 272 in correspondence to the port that has received the data (step S509), and completes the connection control process.

In the step S502, when the data has not been received at the port at the side of the terminal device 260, but received at the port at the side of the authentication server device 280 (step S502, No), as shown in FIG. 22B, the communication processing unit 271 checks whether the received data is the judgment result data sent in response to the security countermeasure level transfer data 320 sent to the authentication server device 280 or not (step S511).

When the received data is the judgment result data (step S511, Yes), the connection control unit 273 searches for a port having the identification information that corresponds to the identification information included in the judgment result data from the port control table 272 (step S512), and checks whether there is a port whose identification information corresponds to the identification information included in the judgment result data or not (step S513).

When there is a port whose identification information corresponds to the identification information included in the judgment result data (step S513, Yes), the connection control unit 273 checks whether the authentication has succeeded or not from the authentication judgment result (step S514), and when the authentication has succeeded (step S514, Yes), the connection control unit sets the port status “connection permission” or “connection rejection” in correspondence to the port whose identification information corresponds, according to the judgment result included in the authentication judgment result data (step S515), and clears the identification information of the port control table 272 (step S516), and completes the connection control process.

When the authentication fails (step S514, No), the connection control unit 273 sets the port status of “connection rejection” in correspondence to the port whose identification information corresponds (step S519), and clears the identification information of the port control table 272 (step S516), and completes the connection control process.

In the step S513, when there is not any port whose identification information corresponds (step S513, No), the connection control unit 273 deletes the authentication judgment result data (step S517), and completes the connection control process.

In the step S511, when the received data is not the authentication judgment result data (step S511, No), the connection control portion 273 confirms the port status of the port corresponding to the destination of the data concerned in the port control table 272 (step S518), and as shown in FIG. 22A, the connection control portion checks whether the port status is “connection rejection” or not (step S505).

When the port status is not “connection rejection” (step S505, No), the connection control unit 273 sends the data received from the authentication server device 280 to a terminal device or a server device at destination (step S506), and completes the connection control process. When the port status is “connection rejection” (step S505, Yes), the connection control unit 273 deletes the data received from the authentication server device 280 (step S510), and completes the connection control process.

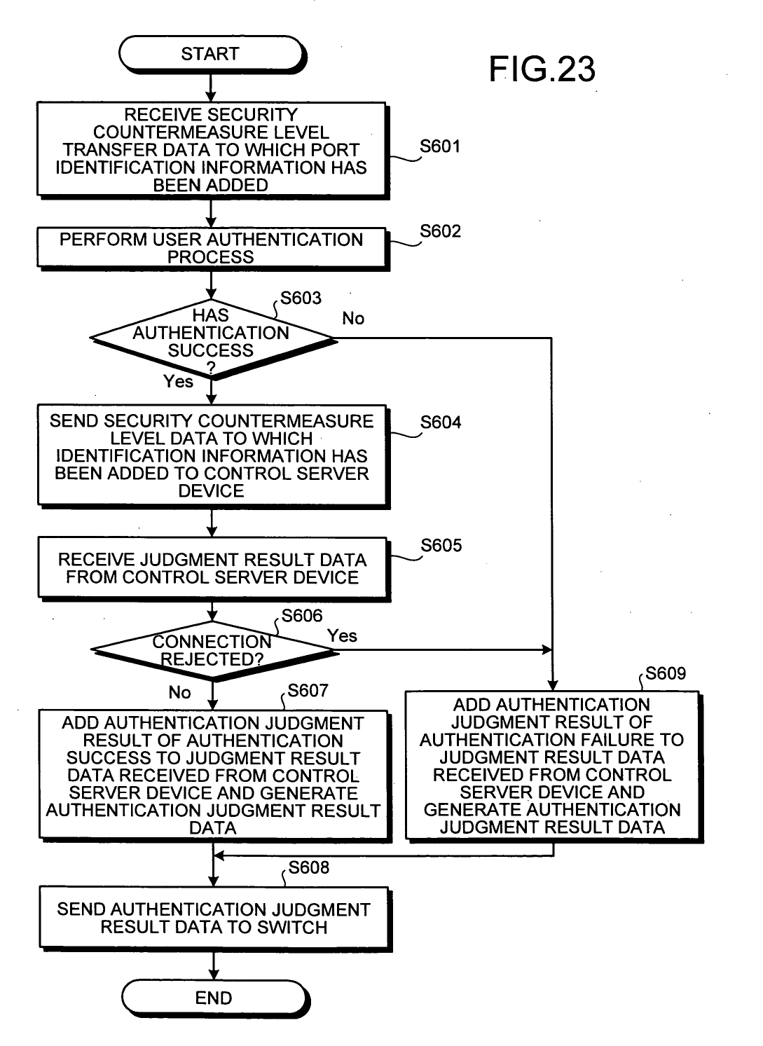

The process procedure for the user authentication process that the authentication server device 280 according to the fifth embodiment performs is explained hereinafter. FIG. 23 is a flow chart of the process procedure of the user authentication process that the authentication server device 280 according to the fifth embodiment performs.

As shown in FIG. 23, first, the communication processing unit 281 of the authentication server device 280 receives the security countermeasure level transfer data 320 to which the port identification information has been added (step S601). The authentication process unit 283 compares the authentication information included in the security countermeasure level transfer data 320, and the authentication information registered in the user authentication data 282, and performs the user authentication process (step S602).

Then, the authentication process unit 283 check whether the user authentication has succeeded or not (step S603), and when the user authentication has succeeded (step S603, Yes), the authentication process unit sends the security countermeasure level data to which the identification information has been added, to the control server device 290 (step S604).

The authentication process unit 283 receives the judgment result data from the control server device 290 (step S605), and checks whether the judgment result of connection propriety included in the judgment result data is “connection rejection” or not (step S606).

When the judgment result is not “connection rejection” (step S606, No), the authentication process unit 283 adds the authentication judgment result of authentication success to the judgment result data received from the control server device 290 and thereby generates authentication judgment result data (step S607), and sends the authentication judgment result data via the communication processing unit 281 to the switch 270 (step S608).

When the judgment result is “connection rejection” (step S606, Yes), the authentication process unit 283 adds the authentication judgment result of authentication failure to the judgment result data received from the control server device 290 and thereby generates authentication judgment result data (step S609), and sends the authentication judgment result data via the communication processing unit 281 to the switch 270 (step S608).

In the step S603, when the user authentication has not succeeded (step S603, No), the authentication process unit 283 adds the authentication judgment result of authentication failure to the identification information and thereby generates authentication judgment result data (step S609), and sends the authentication judgment result data via the communication processing unit 281 to the switch 270 (step S608).

By the way, in the fifth embodiment, the connection authentication of the terminal device 260 that is connected to the network 300 is performed, while in place of this, as shown in the second embodiment, the connection authentication of the terminal device that is connected to VLAN may be performed.

As mentioned above, in the fifth embodiment, when the connection authentication of the terminal device 260 by the authentication process unit 283 of the authentication server device 280 fails, the communication processing unit 271 of the switch 270 receives the connection rejection information of the terminal device 260 to the network 300 generated by the authentication process unit 283 of the authentication server device 280, and the connection control unit 273 of the switch 270 rejects the connection of the terminal device 260 to the network 300, on the basis of the connection rejection information, accordingly, by further performing the connection authentication, the fifth embodiment makes it possible to appropriately prevent a computer virus from infecting from a computer whose security countermeasures are insufficient to other computers connected to the network.

By the way, in the first embodiment through the fifth embodiment, when the terminal device sends the security countermeasure level data, the port control table of the switch to set the connection control to the network is updated, while in place of this, the terminal device may connect to the update server device and update the software, and when the security countermeasure level is updated, the terminal device may send the security countermeasure level data again, thereby the port control table of the switch may be updated efficiently.

Therefore, in a sixth embodiment, a case wherein when the security countermeasure level has been updated, the terminal device sends the security countermeasure level data again, thereby the port control table of the switch is updated efficiently is explained hereinafter.

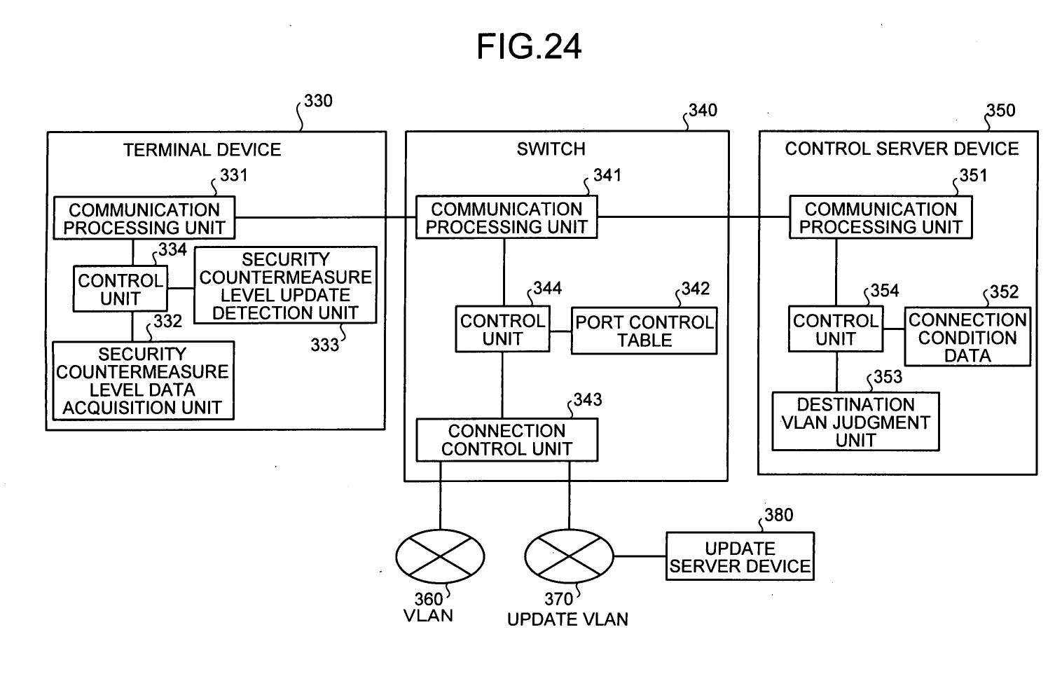

FIG. 24 is a functional block diagram of a network connection control system according to the sixth embodiment. By the way, detailed explanations about the similar functional units to the functional units in the second embodiment shown in FIG. 9 are omitted hereinafter.

As shown in FIG. 24, in this network connection control system, a terminal device 330 and a switch 340 are connected with each other, and the switch 340 and a control server device 350 are connected with each other, and a VLAN 360, and an update VLAN 370 to which an update server device 380 is connected are connected to the switch 340.

The update VLAN 370 is a VLAN wherein the terminal device 330 is connected to an update server device 380 that can update an OS or an anti virus software program, while the VLAN 360 is a VLAN that is used when the terminal device 360 carries out communications with other terminal device or server device (not shown).

The terminal device 330 is a terminal device such as a personal computer to which various application software programs are installed. The terminal device 330 includes a communication processing unit 331, a security countermeasure level data acquisition unit 332, a security countermeasure level update detection unit 333, and a control unit 334.

The communication processing unit 331 is a communication processing unit that carries out communications with the switch 340, and other terminal devices and server devices connected via the VLAN 360 or the update VLAN 370. The security countermeasure level data acquisition unit 332 is an acquisition unit that acquires the computer virus countermeasure conditions of the terminal device 330 as security countermeasure level data. The acquired security countermeasure level data is sent by the communication processing unit 331 to the switch 340.

The security countermeasure level update detection unit 333 detects that the terminal device 330 is connected to the update VLAN 370, and the software is updated by communications with the update server device 380, and instructs the security countermeasure level data acquisition unit 332 to acquire the security countermeasure level data again, and, the acquired security countermeasure level data is sent again by the communication processing unit 331 to the switch 340.

The control unit 334 is a control unit that entirely controls the terminal device 330, and sends and receives data with the respective functional units.

The respective functional units of the switch 340 and the control server device 350 have functions similar to those of the respective functional units of the switch 90 and the control server device 100 shown in FIG. 9.

Namely, the switch 340 relays the data received from the terminal device 330, and controls connection to the VLAN 360 or the update VLAN 370 to which the terminal device or the server device at communication destination is connected.

The switch 340 not only relays data, but also, when it receives the security countermeasure level data from the terminal device 330, it transfers the received security countermeasure level data to the control server device 350. The control server device 350 judges the VLAN to which the terminal device 330 should be connected, on the basis of the sent security countermeasure level data.

Then, the switch 340 receives the judgment result that is sent by the control server device 350, and memorizes the VALN information into the port control table 342 in correspondence with the port to which the terminal device 330 is connected. When the data is sent by the terminal device 330, on the basis of the memorized VLAN information, the switch carries out a process to connect the terminal device 330 to the VLAN 360 or the update VLAN 370 or a process to reject the connection.

The control server device 350 receives the security countermeasure level data from the switch 340, and judges the VLAN to which the terminal device 330 should be connected, on the basis of the security countermeasure level data.

By the way, in the sixth embodiment, the functional unit to detect the update of the security countermeasure level is added to the terminal device in the second embodiment, while in place of this, the same functional unit may be added to the terminal device in the third embodiment through the fifth embodiment, thereby the process to detect that the software has been updated may be performed.

As mentioned above, in the sixth embodiment, when the security countermeasure level update detection unit 333 of the terminal device 330 detects that the terminal device 330 is connected to the update VLAN 370, and the software is updated, the communication processing unit 341 of the switch 340 accepts the information of the VLAN 360 or the update VLAN 370 to which the terminal device 330 is connected, judged by the control server device 350 on the basis of the updated security countermeasure level data of the terminal device 330, and the connection control unit 343 of the switch 340 limits the VALN that the terminal device 330 permits to connect to the VLAN 360 or the update VLAN 370 on the basis of the accepted data, accordingly, when the security countermeasure level of the terminal device 330 is updated, the update concerned may be reflected efficiently to the connection restriction of the terminal device 330.

By the way, in the sixth embodiment, when the security countermeasure level of the terminal device is updated, the terminal device sends again the security countermeasure level data, and the port control table of the switch is updated, while in place of this, when the connection condition data of the control server device wherein the security countermeasure level conditions that the terminal device should satisfy are registered is updated, a request may be made for the terminal device to send the security countermeasure level data, and thereby the conditions of the connection control of the terminal device to the network may be changed promptly on the basis of the updated connection condition data.

Therefore, in a seventh embodiment, a case wherein when the connection condition data of the control server device is updated, a request is made for the terminal device to send the security countermeasure level data, and thereby the conditions of the connection control of the terminal device to the network are changed on the basis of the security countermeasure level data and the updated connection condition data is explained hereinafter.

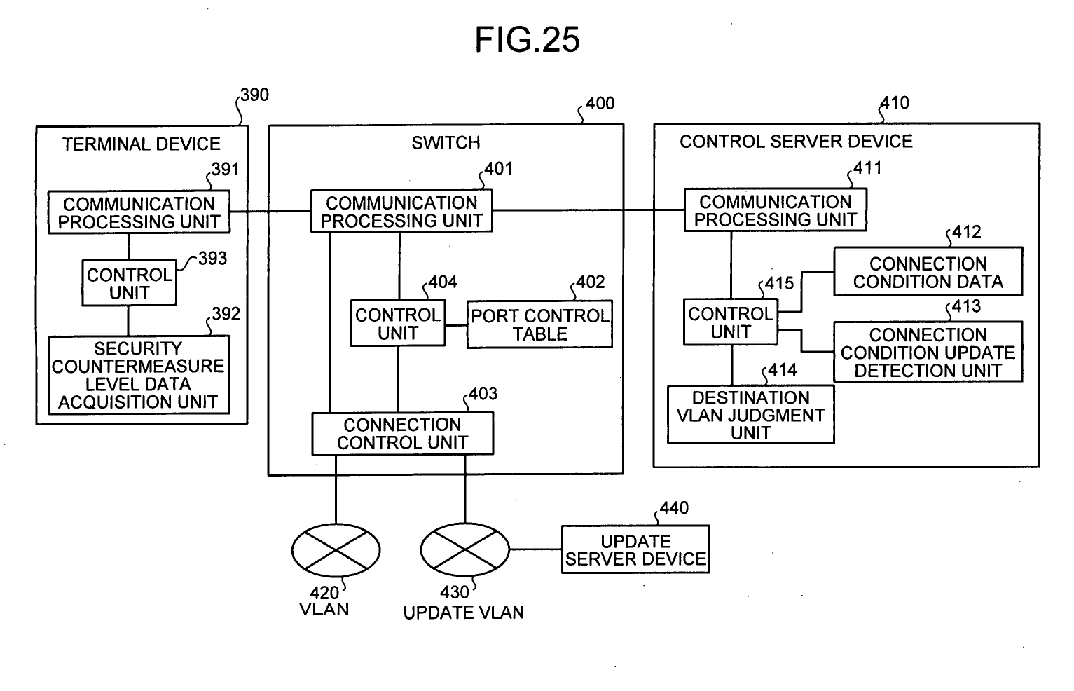

FIG. 25 is a functional block diagram of a network connection control system according to the seventh embodiment. By the way, detailed explanations about the similar functional units to the functional units in the second embodiment shown in FIG. 9 are omitted hereinafter.

As shown in FIG. 25, in this network connection control system, a terminal device 390 and a switch 400 are connected with each other, and the switch 400 and a control server device 410 are connected with each other, and a VLAN 420, and an update VLAN 430 to which an update server device 440 is connected are connected to the switch 400.

The update VLAN 430 is a VLAN wherein the terminal device 390 is connected to the update server device 440 that can update an OS or an anti virus software program, while the VLAN 420 is a VLAN that is used when the terminal device 390 carries out communications with other terminal device or server device (not shown).

The terminal device 390 is a terminal device such as a personal computer to which various application software programs are installed. The terminal device 390 includes a communication processing unit 391, a security countermeasure level data acquisition unit 392, and a control unit 393.

The communication processing unit 391 is a communication processing unit that carries out communications with the switch 400, and other terminal devices and server devices connected via the VLAN 360 or the update VLAN 370. The communication processing unit 391, when it receives the security countermeasure level send request that is sent by the control server device 410, instructs the security countermeasure level data acquisition unit 392 to acquire the security countermeasure level data, and sends the acquired security countermeasure level data to the switch 400.

The security countermeasure level data acquisition unit 392 is an acquisition unit that acquires the computer virus countermeasure conditions of the terminal device 390 as security countermeasure level data. The acquired security countermeasure level data is sent by the communication processing unit 391 to the switch 400.

The control unit 393 is a control unit that entirely controls the terminal device 390, and sends and receives data with the respective functional units.

The respective functional units of the switch 400 have functions similar to those of the respective functional units of the switch 90 shown in FIG. 9. Namely, the switch 400 relays the data received from the terminal device 390, and controls connection to the VLAN 420 or the update VLAN 430 to which the terminal device or server device at communication destination is connected.

The switch 400 not only relays data, but also, when it receives the security countermeasure level data from the terminal device 390, it transfers the received security countermeasure level data to the control server device 410. The control server device 410 judges the VLAN to which the terminal device 390 should be connected, on the basis of the sent security countermeasure level data.

Then, the switch 400 receives the judgment result sent by the control server device 410, and memorizes the VALN information into the port control table 402 in correspondence with the port to which the terminal device 390 is connected. When the data is sent by the terminal device 390, on the basis of the memorized VLAN information, the switch carries out a process to connect the terminal device 390 to the VLAN 420 or the update VLAN 430 or a process to reject the connection.

The control server device 410 is a server device that receives the security countermeasure level data from the switch 400, and judges the VLAN to which the terminal device 390 should be connected, on the basis of the security countermeasure level data.

The control server device 410 includes a communication processing unit 411, connection condition data 412, a connection condition update detection unit 413, a connection destination VLAN judgment unit 414, and a control unit 415. The communication processing unit 411 is a communication processing unit that performs communications with the switch 400, and receives the security countermeasure level transfer data sent from the switch 400, and sends out judgment result data of the VLAN to which the terminal device 390 should be connected to the switch 400.

The connection condition data 412 is data similar to the connection condition data 102 shown in FIG. 12, and is referred to at the moment to judge the VLAN to which the terminal device 390 should be connected, and memorizes the conditions to decide the connection destination VLAN.

The connection condition update detection unit 413 detects changes in the security countermeasure level item kinds, judgment conditions, condition satisfaction VLAN switching destination information or condition dissatisfaction VLAN switching destination information registered in the connection condition data 412, and sends request data that requests the terminal device 390 to send the security countermeasure level data again.

The connection destination VLAN judgment unit 414 judges whether the respective items of the security countermeasure level data that the communication processing unit 411 has received satisfy the respective judgment conditions memorized in the connection condition data 412 or not, and sends the judgment result of the VLAN to which the terminal device 80 should be connected, via the communication processing unit 411 to the switch 400.

The control unit 415 is a control unit that entirely controls the terminal device 410, and sends and receives data with the respective functional units.

By the way, in the seventh embodiment, the functional unit to detect the update of the connection condition data is added to the control server device in the second embodiment, while in place of this, the same functional unit may be added to the terminal device in the third embodiment through the sixth embodiment, thereby the process to detect the update of the connection condition data may be performed.

In the seventh embodiment, when the connection condition data 412 of the control server device 410 is updated, the control server device 410 requests the terminal device 330 to send the security countermeasure level data again, while in place of this, as shown in the sixth embodiment, when the terminal device 330 has already sent the security countermeasure level data, the VLAN that the terminal device 330 permits to connect may be set without making a send request.

As mentioned above, in the seventh embodiment, when the connection condition update detection unit 413 of the control server device 410 detects that the connection condition data 412 of the control server device 410 has been updated, the communication processing unit 341 of the switch 340 accepts the information of the VLAN 360 or the update VLAN 370 to which the terminal device 330 should be connected, on the basis of the security countermeasure level data resent from the terminal device 330, and the connection control unit 343 of the switch 340 limits the VALN that the terminal device 330 permits to connect to the VLAN 360 or the update VLAN 370, accordingly, when the connection condition data 412 of the control server device 410 is updated, the update may be reflected efficiently to the connection restriction of the terminal device 330.

The embodiments according to the present invention have been explained heretofore, while the concrete structural forms thereof are not limited to those embodiment explained above, but the present invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

For example, in the first embodiment through the seventh embodiment, a program that realizes the functions of the terminal device, the switch, the control server device and the authentication server device may be recorded into a recording medium from which the program may be read by a computer, and the program recorded in this recording medium may be read and run by the computer to realize the respective functions.

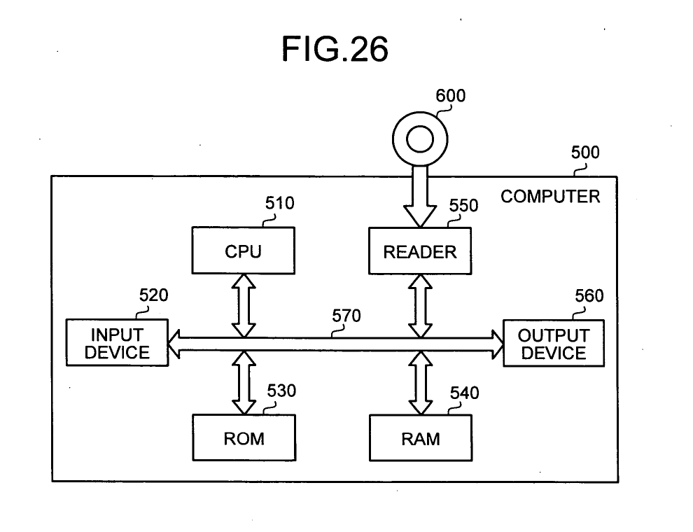

FIG. 26 is a block diagram showing the structure of a computer 500 in a modified example of the embodiment. The computer 500 shown in FIG. 26 includes a CPU (Central Process Unit) 510 that runs the above program, an input device 520 including a keyboard, a mouse or so, a ROM (Read Only memory) 530 that memorizes various kinds of data, a RAM (Random Access memory) 540 that memorizes calculation parameters and the like, a reader 550 that reads the program from a recording medium 600 that records the program that realizes the functions of the terminal device, the switch, the control server device and the authentication server device, and an output device 560 including a display, a printer and the like.

The CPU 510 reads the program recorded in the recording medium 600 via the reader 550, and then runs the program, thereby realizes the functions mentioned above. By the way, as the recording medium 600, an optical disk, a flexible disk, a hard disk and the like may be employed. The program may be introduced to the computer 500 via a network including internet and the like.

Further, in the first embodiment through the seventh embodiment, the switch and the control server device are arranged separately; however, a switch may be so structured to realize both the functions of the switch and those of the control server device. In the same manner, in the fifth embodiment, the switch, the authentication server device, and the control server device are arranged separately; however, a switch may be so structured to realize both the functions of the switch and those of the authentication server device, furthermore, a switch may be so structured to realize all the functions of the switch, those of the authentication server device, and those of the control server device.

According to the present invention, connection control information concerning connection control generated on the basis of security countermeasure condition information concerning computer security countermeasure conditions of a specified computer is accepted, and on the basis of the accepted connection control information, the connection of the specified computer to a network is controlled, accordingly, it is possible to appropriately prevent a computer being infected by a computer virus from another computer whose security countermeasures are insufficient.

According to the present invention, the connection of a specified computer to the network is accepted or rejected on the basis of the accepted connection control information, thereby the connection of computers whose security countermeasures are insufficient is rejected, accordingly, a further effect is attained to appropriately prevent a computer virus from infecting to other computers connected to the network.

Further, according to the present invention, when a network is divided into plural networks, networks that permit the connection of specified computers in plural networks are limited on the basis of the accepted connection control information, and those networks to which computers whose security countermeasures are insufficient are blocked, and the connection to other networks than specified is rejected, accordingly, a still further effect is attained to appropriately prevent a computer virus from infecting to other computers connected to the network.

Still further, according to the present invention, when a specified computer is set enable to communicate via a network, the network which permits the connection of the specified computer is restricted, and a network to which the connection is permitted accepts connection control information generated on the basis of security countermeasure condition information of the restricted specified computer, thereby networks to which computers whose security countermeasures are insufficient are blocked when computers are set enable to communicate via networks, and communications with other computers than designated are rejected, accordingly, another effect is attained to appropriately prevent a computer virus from infecting to other computers connected to the network.

Moreover, according to the present invention, computers at communication destinations to communicate with a specified computer are limited on the basis of accepted connection control information, and the connection of the specified computer to network is permitted or rejected, thereby computers at communication destinations whose security countermeasures are insufficient are restricted, and communications with other computers than designated are rejected, accordingly, further another effect is attained to appropriately prevent a computer virus from infecting to other computers connected to the network.

According to the present invention, when a specified computer is set enable to communicate via a network, computers at communication destinations to communicate with the specified computer are limited, and computers at communication destinations accepts connection control information generated on the basis of security countermeasure condition information of the restricted specified computer, and computers at communication destinations whose security countermeasures are insufficient to communicate with the specified computer are limited when computers are set enable to communicate via networks, and communications with other computers than designated are rejected, accordingly, still further another effect is attained to appropriately prevent a computer virus from infecting to other computers connected to the network.

Still further, according to the present invention, after connection control of a specified computer to network, when the security countermeasure condition information of the specified computer is updated, connection control information concerning connection control generated on the basis of the updated security countermeasure condition information is accepted, and connection control of the specified computer to network is updated on the basis of the accepted connection control information, accordingly, another effect is attained to effectively reflect an update of security countermeasures of computers connected to the network to the connection control of computers to the network.

Moreover, according to the present invention, when connection control conditions to specify the connection control of a specified computer to network are updated, connection control information concerning connection control generated on the basis of security countermeasure condition information and connection control conditions is accepted again, and the connection control of the specified computer to network is updated on the basis of the accepted connection control information, accordingly, still another effect is attained to effectively reflect an update of the connection control conditions that specify the connection control of computers, to the connection control of computers to the network.

According to the present invention, information concerning connection authentication of a specified computer is further accepted, and the connection control procedures reject the connection of the specified computer to network when information concerning the connection authentication accepted by the connection control information acceptance procedures is information showing authentication failure, and thereby information of connection authentication results of computers is accepted, accordingly, still further another effect is attained to further appropriately prevent a computer virus from infecting from a computer whose security countermeasures are insufficient to other computers connected to the network.

Still further, according to the present invention, connection authentication of a specified computer is further performed, and when the connection authentication fails, connection of the specified computer to network is rejected, and connection authentication of the computer is further performed, accordingly, a still another effect is attained to further appropriately prevent a computer virus from infecting from a computer whose security countermeasures are insufficient to other computers connected to the network.

Moreover, according to the present invention, security countermeasure condition information concerning computer security countermeasure conditions of a specified computer is accepted, and whether the security countermeasure conditions are sufficient or not is judged, and the connection of the specified computer to network is controlled on the basis of the judged judgment result, accordingly, a still another effect is attained to appropriately prevent a computer virus from infecting from a computer whose security countermeasures are insufficient to other computers connected to the network.

According to the present invention, connection authentication of a specified computer is further performed, and when the connection authentication fails, the connection of the specified computer to network is rejected, accordingly, yet a further effect is attained to further appropriately prevent a computer virus from infecting from a computer whose security countermeasures are insufficient to other computers connected to the network.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A network connection control program that is run on a computer and relays communications by specified computers via a network, and controls connections of the specified computers to the network, the network connection control program making a computer execute the steps comprising:
accepting connection control information about connection control generated on the basis of security countermeasure condition information about computer security countermeasure conditions of specified computers; and
controlling the connections of the specified computers to the network on the basis of the connection control information accepted at the accepting step.

2. The network connection control program according to claim 1, wherein the controlling step includes any one of permitting and rejecting the connection of the specified computers to the network on the basis of the connection control information accepted at the accepting step.

3. The network connection control program according to claim 1, wherein the controlling step includes, when the network includes plural sub-networks, limiting the connection of the specified computers in the sub-networks on the basis of the connection control information accepted at the accepting step.

4. The network connection control program according to claim 3, further making the computer execute limiting networks that are allowed to be connected to the specified computers, when the specified computers are set enable to communicate via the network, wherein
the accepting step includes accepting the connection control information generated on the basis of the security countermeasure condition information of the specified computers that are allowed to be connected to the networks in the limiting networks.

5. The network connection control program according to claim 1, wherein the controlling step includes any one of permitting and rejecting the connection of the specified computers to the network by limiting communication destination computers that communicate with the specified computers on the basis of the connection control information accepted at the accepting step.

6. The network connection control program according to claim 5, further making the computer execute limiting communication destination computers that communicate with the specified computers, when the specified computers are set enable to communicate via the network, wherein
the accepting step includes accepting the connection control information generated on the basis of the security countermeasure condition information of the specified computers to which the communication destination computers are limited at the limiting step.

7. The network connection control program according to claim 1, further making the computer execute the steps comprising:
reaccepting, when the security countermeasure condition information of the specified computers is updated, after the connection control of the specified computers to the network is performed at the controlling step, the connection control information about connection control generated on the basis of the updated security countermeasure condition information; and
updating the connection control of the specified computers to the network on the basis of the connection control information accepted at the reaccepting.

8. The network connection control program according to claim 1, further making the computer execute the steps comprising:
reaccepting, when the connection control conditions that specify the connection control of the specified computers to the network on the basis of the security countermeasure condition information are updated, the security countermeasure condition information and the connection control information about connection control generated on the basis of the connection control conditions; and
updating the connection control of the specified computers to the network on the basis of the connection control information accepted at the reaccepting step.

9. The network connection control program according to claim 1, wherein the accepting step includes accepting information about the connection authentication of the specified computers, and the controlling step includes rejecting the connection of the specified computers to the network, when the information about the connection authentication accepted at the accepting step is information showing authentication failure.

10. The network connection control program according to claim 1, wherein the accepting step includes performing connection authentication of the specified computers, and the controlling step includes rejecting the connection of the specified computers to the network, when the connection authentication at the controlling step.

11. A network connection control program that is run on a computer and relays communications by specified computers via a network, and controls connections of the specified computers to the network, the network connection control program making a computer execute the steps comprising:
accepting security countermeasure condition information about computer security countermeasure conditions of the specified computers;
judging whether the security countermeasure conditions accepted are sufficient; and
controlling the connections of the specified computers to the network on the basis of a result obtained at the judging step.

12. The network connection control program according to claim 11, wherein the judging step includes performing connection authentication of the specified computers, and the controlling includes rejecting the connection of the specified computers to the network, when the connection authentication fails.

13. A network connection control method of relaying communications by specified computers via a network, and controlling connections of the specified computers to the network, comprising:
accepting connection control information about connection control generated on the basis of security countermeasure condition information about computer security countermeasure conditions of specified computers; and
controlling the connections of the specified computers to the network on the basis of the connection control information accepted at the accepting.

14. A network connection control method of relaying communications by specified computers via a network, and controlling connections of the specified computers to the network, comprising:
accepting security countermeasure condition information about computer security countermeasure conditions of the specified computers;
judging whether the security countermeasure conditions accepted are sufficient; and
controlling the connections of the specified computers to the network on the basis of a result obtained at the judging.

15. A network connection control device that relays communications by specified computers via a network, and controls connections of the specified computers to the network, comprising:
an accepting unit that accepts connection control information about connection control generated on the basis of security countermeasure condition information about computer security countermeasure conditions of specified computers; and
a controlling unit that controls the connections of the specified computers to the network on the basis of the connection control information accepted by the accepting unit.

16. A network connection control device that relays communications by specified computers via a network, and controls connections of the specified computers to the network, comprising:
an accepting unit that accepts security countermeasure condition information about computer security countermeasure conditions of the specified computers;
a judging unit that judges whether the security countermeasure conditions accepted are sufficient; and
a controlling unit that controls the connections of the specified computers to the network on the basis of a result obtained by the judging unit.
